(19) United States
(12) Patent Application Publication
(10) Pub. No.: US 2024/0225008 A1
(43) Pub. Date: Jul. 11, 2024

(54) Blended Compositions for Biological Contaminant Removal Containing Trivalent Doped Cerium Oxide and Silver Zinc Zeolite

(71) Applicant: Neo Chemicals & Oxides, LLC, Greenwood Village, CO (US)

(72) Inventors: Dimitrios Psaras, Bound Brook, NJ (US); Mason Reames Haneline, Orange, CA (US); Steven Paul Williams, Sillamae (EE)

(73) Assignee: Neo Chemicals & Oxides, LLC, Greenwood Village, CO (US)

(21) Appl. No.: 18/410,686

(22) Filed: Jan. 11, 2024

Related U.S. Application Data
(60) Provisional application No. 63/479,518, filed on Jan. 11, 2023.

(51) Int. Cl. A01N 59/16; A01N 25/12; A01P 1/00; C02F 1/50; C08K 3/105; C08K 3/22

(52) U.S. Cl. CPC A01N 59/16; A01N 25/12; A01P 1/00; C02F 1/505; C08K 3/105; C08K 3/22; C02F 2209/36; C02F 2303/04; C08K 2003/2213

(57) ABSTRACT

This disclosure relates to novel blended compositions for biological contaminant removal containing a particulate oxide composition and silver zinc zeolite. The particulate oxide composition is a mixed oxide of at least cerium and trivalent dopant. These blended compositions can be used as antimicrobial/antibacterial/antiviral agents. As such, this disclosure also relates to the use of these blended compositions for biological contaminant removal. The blended compositions have uses for removing bacteria, viruses, protozoa (e.g., amoebae), fungi (e.g., mold), algae, yeast, and the like. In particular, these blended compositions can be used in methods for treating fluids, including liquids or air, and solid surfaces through contact.

### RELATED APPLICATION

This application claims priority to and benefit of U.S. Provisional Application No. 63/479,518 filed Jan. 11, 2023, the contents of which are hereby incorporated by reference in their entirety.

### FIELD OF THE INVENTION

This disclosure relates to novel blended compositions for biological contaminant removal containing trivalent doped cerium oxide (CeO₂) particulate compositions and silver zinc zeolite. These blended compositions can be used as antimicrobial/antibacterial/antiviral agents. As such, this disclosure also relates to the use of these blended compositions for biological contaminant removal. The blended compositions have uses for removing bacteria, viruses, protozoa (e.g., amoebae), fungi (e.g., mold), algae, yeast, and the like. In particular, these compositions can be used in methods for treating fluids, including liquids or air, and solid surfaces through contact.

### INTRODUCTION

Various technologies have been used to remove biological contaminants from air and aqueous systems. Examples of other techniques for removing biological contaminants include adsorption on high surface area materials, such as alumina, filters with pore sizes smaller than the biological contaminants, and the use of highly oxidative materials such as chlorine and bromine. Certain metals have also found use because they exhibit the oligodynamic effect which is the biocidal effect of metals. Metals known to exhibit the oligodynamic effect are Al, Sb, As, Ba, Si, B, Cu, Au, Pb, Hg, Ni, Ag, Th, Sn, and Zn. Incorporation of these into technologies for air or aqueous system treatment remains a challenge as the toxicity towards human and animal life and the cost are major concerns. In particular, silver has been used widely for its antibacterial activity in medical and consumer products because of its broad range of activity. Despite the many beneficial innovations in the use of silver as an antimicrobial agent, its application may have negative environmental impacts and it has potential to exert toxic effects on keratinocytes and fibroblasts. At a minimum, silver is known to cause skin irritation; therefore, there has been an effort to minimize its use.

The need for effective and inexpensive antimicrobial materials to remove bacteria, viruses, and other microbial contaminants, from fluids, including air, water, and other aqueous systems, remains.

### SUMMARY

This disclosure relates generally to novel blended compositions containing a particulate oxide composition and silver zinc zeolite and the use of these blended compositions for removing biological contaminants. The particulate oxide composition within the blended composition is a trivalent doped cerium oxide, i.e., a mixed oxide of at least cerium and a trivalent dopant.

Disclosed herein is a blended composition for biological contaminant removal. The blended composition comprises less than about 50% to about 1% by weight of a silver zinc zeolite and greater than about 50% to about 99% by weight of a particulate oxide composition. The particulate oxide composition within the blended composition comprises cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof; wherein the cerium oxide is present in an amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition.

In particular embodiments, the average trivalent dopant to Ce ratio at about 0 nm to about 3.5 nm from the surface of the particulate composition is about 10% to about 250% greater than the trivalent dopant to Ce ratio at about 15 nm from the surface of the particulate oxide composition. In other embodiments, the average trivalent dopant to Ce ratio at about 0 nm to about 3.5 nm from the surface of the particulate composition is about 15% to about 250% greater than the trivalent dopant to Ce ratio at about 15 nm from the surface of the particulate oxide composition.

In certain embodiments of the particulate oxide compositions, the particulate oxide comprises cerium oxide in an amount of about 99.9 wt % to about 20 wt % based on the total weight of the particulate oxide composition; trivalent dopant in an amount of about 0.1 wt % up to about 50 wt % based on the total weight of the particulate oxide composition; and additional metal oxide in an amount of about 70 wt % to about 0 wt % based on the total weight of the particulate oxide composition. And in specific, there is about 0 wt % additional metal oxide.

The blended compositions have biological contaminant removal properties, and as such, have uses for removing bacteria or viruses from fluids, including air and water, and/or from surfaces. The biological contaminants to be removed include bacteria, viruses, protozoa (e.g., amoebae), fungi (e.g., mold or fungus), and the like. The blended compositions allow for reduced amount of silver zinc zeolite while retaining this activity, and the blended compositions exhibit better activity than the silver zinc zeolite or the particulate oxide compositions alone. As such, the blended compositions exhibit unexpected synergistic activity for removing/reducing biological contaminants.

Also disclosed herein are supported compositions comprising a support material and the blended compositions. The supported compositions have biological contaminant removal properties, and as such, has uses for removing bacteria or viruses from fluids, including air and water, and/or from surfaces.

The supported compositions for removing biological contaminants as disclosed herein comprises a support material comprising an organic polymer, cotton, glass fiber, or mixtures thereof and the blended composition as described herein. In these supported compositions, the blended composition for biological contaminant removal is deposited on or within the support material.

In specific embodiments, the supported compositions comprise about 0.5 to about 80 weight % blended composition based on the total weight of the supported composition.

The supported composition containing the support material and blended composition is in a rigid or elastic form and this supported composition can be made into an article for removing biological contaminants, such as a filter, a fixed bed filter system, a plastic or glass bottle or container, a plastic or glass touch surface, and the like.

In one embodiment, a plastic article is disclosed. This plastic article comprises: a supported composition for removing biological contaminants comprising (i) an organic polymer selected from the group consisting of polyethylene, polyvinyl chloride, nylon, polypropylene, polyester, polyurethane, polyamide, polyolefin, polycarbonate, copolymers thereof, and mixtures thereof; and (ii) the blended composition as described herein, wherein in the supported composition, the blended composition is deposited on or within the organic polymer. The plastic article comprises about 50 to about 100 weight percent of the supported composition for removing biological contaminants based on the total weight of the plastic article. The plastic article can be a filter, a fixed bed filter system, a plastic bottle or container, a plastic touch surface, a plastic doorknob or handle cover, a plastic elevator button cover, and the like.

The blended compositions per se, the supported compositions, and the articles can be used in methods for removing biological contaminants. These biological contaminants include bacteria, viruses, protozoa (e.g., amoebae), fungi (e.g., mold or fungus), and the like.

In one embodiment the method for removing biological contaminants comprises: (i) providing a blended composition as described herein; (ii) contacting the blended composition with a biological contaminant wherein the biological contaminant is selected from the group consisting of bacteria, viruses, fungi, protozoa (e.g., amoebae), and mixtures thereof; and (iii) removing at least about 90% of the biological contaminant through contact with the blended composition. In some embodiments, the blended composition is contained within a filter material or a plastic.

In certain embodiments the methods treat an aqueous stream, and the biological contaminant is in the aqueous stream. In other embodiments, the methods treat a gaseous stream, and the biological contaminant is in the gaseous stream. In yet other embodiments, the contacting is through touch of a solid to the composition and thus treat a solid surface through touch. In certain of these embodiments, the contacting is through touch of a solid to an article comprising the particulate oxide composition.

In specific embodiments of treating a fluid (e.g., a gaseous or aqueous stream), the methods may further comprise a step of setting a target concentration of biological contaminant. In these embodiments, a biological contaminant may be identified and a target concentration for that biological contaminant may be set. The methods additionally may comprise a step of monitoring the treated stream for the biological contaminant. The monitoring may be done by sampling or may be continuous.

In a certain embodiment, these methods are for removing biological contaminants from fluid and the methods are for treating a fluid. In these embodiments, the fluid may be a gaseous or aqueous stream. The methods comprise (i) providing a blended composition as described herein; (ii) contacting a fluid (e.g., a gaseous or aqueous stream) containing biological contaminant with the blended composition, wherein the biological contaminant is selected from the group consisting of bacteria, viruses, fungi (e.g., mold), protozoa (e.g., amoebae), and mixtures thereof; and (iii) removing biological contaminant from the fluid (e.g., gaseous or aqueous stream) through contact with the blended composition. The biological contaminant can be removed in an amount of 90% or more. When the fluid is a liquid, the blended composition may be used per se and the method may further comprise filtering the fluid/liquid.

In specific embodiments, these methods are for removing biological contaminants from fluid using a supported composition. In these embodiments, the fluid may be a gaseous or aqueous stream. The methods comprise (i) providing a supported composition comprising (a) a support material comprising an organic polymer, cotton, glass fiber, or mixtures thereof and (b) the blended composition as described herein; (ii) contacting a fluid containing biological contaminant with the supported composition, wherein the biological contaminant is selected from the group consisting of bacteria, viruses, fungi (e.g., mold), protozoa (e.g., amoebae), and mixtures thereof; and (iii) removing biological contaminant from the fluid through contact with the supported composition. The biological contaminant can be removed in an amount of 90% or more.

These methods of treating a fluid or a gaseous or aqueous stream using the blended compositionper se or a supported composition may further comprise a step of setting a target concentration of biological contaminant. In these methods a biological contaminant of interest is identified and then a target concentration for that biological contaminant is set. The methods additionally may comprise a step of monitoring the biological contaminant in the treated stream. The monitoring may be done by sampling or may be continuous.

In methods of treating aqueous streams, the blended composition may be used per se by slurrying with the aqueous stream. These methods including slurrying may further comprise a step of filtering.

In specific embodiments, the methods comprise the steps of (i) providing a supported composition comprising (a) a support material comprising an organic polymer, cotton, glass fiber, or mixtures thereof and (b) the blended compositions as described herein; (ii) setting a target concentration of a biological contaminant; (iii) contacting a gaseous or aqueous stream containing biological contaminant with the supported composition and removing biological contaminant through contact with the supported composition to provide a treated stream; and (iv) monitoring the treated stream for the biological contaminant, wherein the biological contaminant is selected from the group consisting of bacteria, viruses, fungi (e.g., mold), protozoa (e.g., amoebae), and mixtures thereof. The target concentration can be set at a certain amount of contaminant (e.g., virus, bacteria, protozoa/amoebae, or fungi) or can be set at the limit of detection. The monitoring may be done by sampling or may be continuous.

### BRIEF DESCRIPTION OF THE FIGURES

FIG. 1 is an SEM image of the composition of Example 1 with a scale bar of 200 nm.

FIG. 2 is an SEM image of the composition of Example 1 with a scale bar of 2 μm.

FIG. 3 is a TEM image of the composition of Example 1 with a scale bar of 10 nm. The light field image is on the left and the dark field image is on the right.

FIG. 4 is a TEM image of the composition of Example 1 with a scale bar of 20 nm. The light field image is on the left and the dark field image is on the right.

FIG. 5A is the temperature programed desorption of CO₂ for the composition of Example 1.

FIG. 5B is the temperature programed desorption of CO₂ for the composition of Example 2.

FIG. 5C is the temperature programed desorption of CO₂ for the composition of Example 3.

FIG. 6 is the temperature programed desorption of H₂ for the composition of Example 1, Example 2, and Example 3.

FIG. 7 is the zeta-potential vs pH graph for the composition of Example 1, Example 2, and Example 3.

FIG. 8 is a graph of the ratio of LaO⁺/CeO⁺ vs depth for the composition of Example 1 and the composition of Example 2.

FIG. 9 is a graph of the ratio of PrO⁺/CeO⁺ vs depth for the compositions of Example 4 and Example 5.

FIG. 10 is an SEM image of the composition of Example 2 with a scale bar of 200 nm.

FIG. 11 is an SEM image of the composition of Example 2 with a scale bar of 20 nm.

FIG. 12A is a light field TEM image of the composition of Example 2 with a scale bar of 200 nm. The box indicates the zoom area for FIG. 12B.

FIG. 12B is a light field TEM image of the composition of Example 2 with a scale bar of 20 nm. The box indicates the zoom area for FIG. 12C.

FIG. 12C is a light field TEM image of the composition of Example 2 with a scale bar of 5 nm.

FIG. 12D is a dark field TEM image of the composition of Example 2 with a scale bar of 5 nm.

FIG. 13 is a graph showing the Log removal of MRSA for the series Example 1, Examples 7A-D (blends of Example 1 and 6), and Example 6 (silver zinc zeolite), and this is compared to the series Example 3 (CeO₂), Examples 8B-C (blends of Example 3 and 6), and Example 6 (silver zinc zeolite).

### DETAILED DESCRIPTION

This disclosure generally relates to blended compositions containing silver zinc zeolite and particulate oxide compositions comprising trivalent doped CeO₂. This disclosure also relates to the use of these blended compositions for removing biological contaminants, including bacteria, viruses, and other microbial contaminants, through contact. As such, these blended compositions can remove biological contaminants from air and aqueous liquid streams and can particularly remove bacteria and viruses from air and water whether the microbes are in high or very low concentrations. These blended compositions perform better than silver zinc zeolite alone and allow for use of a reduced amount of silver zinc zeolite while maintaining efficacy for removing biological contaminants. These blended compositions also perform better than the particulate oxide composition alone.

Before the compositions, articles, and methods are disclosed and described in detail, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting. It must be noted that, as used in this specification, the singular forms “a,” “an,” and “the” include plural referents unless the context clearly dictates otherwise. Thus, for example, reference to “a trivalent dopant” is not to be taken as quantitatively or source limiting, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Singular forms of the biological contaminants also include plural referents. For example, “amoeba” and “virus” include reference to “amoebae” and “viruses”, respectively.

Numerical values with “about” or “approximately” include typical experimental variances. As used herein, the terms “about” and “approximately” are used interchangeably and mean within a statistically meaningful range of a value, such as a stated weight percentage, surface area, concentration range, time frame, distance, molecular weight, temperature, pH, and the like. Such a range can be within an order of magnitude, typically within 10%, and even more typically within 5% of the indicated value or range. Sometimes, such a range can be within the experimental error typical of standard methods used for the measurement and/or determination of a given value or range. The allowable variation encompassed by the term “about” will depend upon the particular system under study, and can be readily appreciated by one of ordinary skill in the art. Whenever a range is recited within this application, at least every whole number integer within the range is also contemplated as an embodiment of the invention.

The disclosed blended compositions have activity for removing biological contaminants. These blended compositions contain trivalent doped CeO₂ particulate compositions and silver zinc zeolite. The trivalent doped CeO₂ particulate compositions are also described as particulate oxide compositions and these terms are used interchangeably herein. This particulate oxide compositions are composed of mixed oxides of Ce and a trivalent dopant.

The blended compositions disclosed herein can be used as a slurry or in supported compositions and/or articles that are intended to remove biological contaminants and in methods for removing biological contaminants. These biological contaminants include bacteria, viruses, fungi, protozoa (e.g., amoebae), yeast, and mixtures thereof.

The blended compositions as disclosed herein are for biological contaminant removal and contain less than about 50% to about 1% by weight of a silver zinc zeolite; and (b) greater than about 50% to about 99% by weight of a particulate oxide composition. This particulate oxide composition comprises cerium oxide; trivalent dopant (as an oxide) selected from the group consisting of yttrium (Y), lanthanum (La), neodymium (Nd), praseodymium (Pr), and mixtures thereof; and optionally an additional metal oxide selected from the group consisting of aluminum (Al), titanium (Ti), zirconium (Zr), hafnium (Hf), and mixtures thereof. In this particulate oxide, the cerium oxide is present in an amount greater than the trivalent dopant and the average trivalent dopant to Ce ratio at about 0 nm to about 3.5 nm from the surface of the particulate oxide composition is greater than the trivalent dopant to Ce ratio at about 15 nm from the surface of the particulate composition.

In certain embodiments of the particulate oxide composition, it comprises cerium oxide in an amount of about 99.9 wt % to about 20 wt % based on the total weight of the particulate oxide composition; trivalent dopant in an amount of about 0.1 wt % up to about 50 wt % based on the total weight of the particulate oxide composition; and additional metal oxide in an amount of about 70 wt % to about 0 wt % based on the total weight of the particulate oxide composition.

The blended compositions as disclosed herein contain less than about 50% to about 1% by weight of silver zine zeolite and greater than about 50% to about 99% by weight of the particulate oxide composition. In certain embodiments, the blended compositions comprise about 35% to about 5% by weight of silver zinc zeolite and about 65% to about 95% by weight of the particulate oxide composition. In particular embodiments, the blended compositions comprise about 25% to about 10% by weight of silver zinc zeolite and about 75% to about 90% by weight of the particulate oxide composition.

Within the blended compositions, the silver zinc zeolite (Ze—Ag—Zn: CAS No. 130328-20-0) is a silver and zinc ion surface-modified Linde Type A (LTA) zeolite framework with applications, such as in antimicrobial coatings. LTA zeolite is a crystalline aluminosilicate of well-defined three-dimensional framework that has been surface-modified with both silver and zinc ions. The Ag⁺ content can be approximately 0.4 wt % to approximately 6 wt % and the Zn²⁺ content can be approximately 1 wt % to approximately 16 wt %.

Within the blended composition, the particulate oxide composition is composed primarily of mixed oxides of Ce and a trivalent dopant. These particulate oxide compositions are also described herein as trivalent doped CeO₂ compositions or trivalent doped CeO₂ particulate compositions.

As such, the trivalent doped CeO₂ particulate compositions are mixed oxides of Ce and of a trivalent dopant. In the particulate oxide compositions, the trivalent dopant is selected from the group consisting of yttrium (Y), lanthanum (La), neodymium (Nd), praseodymium (Pr), and mixtures thereof.

In certain embodiments, the particulate oxide compositions also contain an amount of additional metal oxide. This additional metal oxide is selected from the group consisting of aluminum (Al), titanium (Ti), zirconium (Zr), hafnium (Hf), and mixtures thereof.

The blended compositions as disclosed herein perform better than silver zinc zeolite alone and allow for use of a reduced amount of silver zinc zeolite while maintaining efficacy for removing biological contaminants. The blended compositions as disclosed herein also perform better than the particulate oxide composition alone.

Within the blended composition, the trivalent doped CeO₂ compositions or particulate oxide compositions comprise cerium oxide and one or more trivalent dopants (as oxides) and optionally one or more additional metal oxides. As such, the particulate oxide composition comprises cerium oxide, trivalent dopant selected from the group consisting of yttrium (Y), lanthanum (La), neodymium (Nd), praseodymium (Pr), and mixtures thereof (as oxides), optionally one or more additional metal oxides, other than the cerium oxide and trivalent dopant, and/or trace amounts of impurities.

The additional metal oxides within the particulate oxide composition are selected from the group consisting of aluminum, titanium, zirconium, hafnium, and mixtures thereof. In certain embodiments, the particulate oxide composition contains about zero additional metal oxides. In other embodiments, the particulate oxide composition contains additional metal oxides.

The particulate oxide compositions exhibit activity for removing/reducing biological contaminants and are used in the blended compositions also containing silver zinc zeolite. When the two components are used together, the blended compositions allow for reduced amount of silver zinc zeolite while retaining activity, and the blended compositions tend to exhibit better activity than the silver zinc zeolite or the particulate oxide compositions alone. As such, the blended compositions exhibit unexpected synergistic activity for removing/reducing biological contaminants.

The cerium of the cerium oxide in the particulate oxide composition is Ce(IV). The trivalent rare earth dopants can be selected from the group consisting of yttrium (Y), lanthanum (La), neodymium (Nd), praseodymium (Pr), samarium (Sm), europium (Eu), gadolinium (Gd), terbium (Tb), dysprosium (Dy), holmium (Ho), erbium (Er), thulium (Tm), ytterbium (Yb), lutetium (Lu), cerium (Ce), and mixtures thereof. In certain embodiments, the trivalent dopant is yttrium (Y), lanthanum (La), neodymium (Nd), praseodymium (Pr), and mixtures thereof, and in particular embodiments, the trivalent dopant is Nd, La, or a mixture thereof. In other embodiments, the trivalent dopant is La. In additional embodiments, the trivalent dopant is Pr. As described, the trivalent dopant is present within the particulate composition as an oxide so that the particulate oxide composition comprises a mixed oxide of at least cerium and trivalent dopant.

The trivalent dopant is present in a minority amount in comparison to the cerium oxide, and as such, the particulate oxide compositions contain more cerium oxide than trivalent dopant (also present as an oxide).

The particulate oxide composition optionally also may contain additional metal oxides, other than the cerium oxide and trivalent dopant. These additional metal oxides may be selected from the group consisting of aluminum (Al), titanium (Ti), zirconium (Zr), hafnium (Hf), and mixtures thereof.

As such, the particulate oxide composition is a mixed oxide composition (i.e., a mixture of oxides of at least cerium and trivalent dopant). The composition also is identified herein as a trivalent doped cerium oxide, and when identified as such, it is a mixed cerium trivalent dopant oxide, but this description does not exclude the additional metal oxides, unless it is identified that the composition contains about zero additional metal oxides, other than the cerium and trivalent dopant.

In certain embodiments of the particulate oxide composition, the trivalent dopant is La and the particulate oxide composition does contain about zero additional metal oxides. In these embodiments, the particulate oxide composition is a mixed cerium lanthanum oxide (or a La doped cerium oxide).

The particulate oxide composition comprises the trivalent dopant (as an oxide) in an amount of about 0.1 wt % up to about 50 wt % based on the total weight of the particulate oxide composition. As stated above, the trivalent dopant is present in a minority amount in comparison to the cerium oxide. In certain embodiments, the particulate oxide composition contains the trivalent dopant in an amount of about 0.5 wt % to about 40 wt % or in an amount of about 1 wt % to about 40 wt % based on the total weight of the particulate oxide composition. In particular embodiments, the particulate oxide composition contains the trivalent dopant in an amount of about 2 wt % to about 35 wt % or in an amount of about 2 wt % to about 30 wt % based on the total weight of the particulate oxide composition. In additional embodiments, the particulate oxide composition contains the trivalent dopant in an amount of about 2 wt % to about 25 wt % or in an amount of about 5 wt % to about 20 wt % based on the total weight of the particulate oxide composition. In specific of these embodiments, the particulate oxide composition contains the trivalent dopant in an amount of about 15 wt % based on the total weight of the particulate oxide composition. The trivalent dopant is present within the particulate composition as an oxide and these wt % are based on trivalent dopant as an oxide. In certain of any of the above-described embodiments, the trivalent dopant is lanthanum and the particulate oxide composition is cerium oxide doped with lanthanum (i.e., a mixed oxide of cerium and lanthanum).

In embodiments where the particulate oxide composition contains a cerium oxide, one or more trivalent dopants, and about zero additional metal oxide, the amount of cerium oxide will correspond to and vary with the amount of trivalent dopant so that the total amount of the trivalent dopant (as an oxide) and cerium oxide is about 100% of the particulate composition. In certain of these embodiments with about zero additional metal oxide, the trivalent dopant is lanthanum, and the particulate oxide composition is cerium oxide doped with lanthanum.

In the particulate oxide compositions, the cerium oxide is present in an amount greater than trivalent dopant. The particulate oxide composition as disclosed herein generally comprises the cerium oxide in an amount of about 99.9 wt % to about 20 wt % based on the total weight of the particulate oxide composition. In certain embodiments, the particulate oxide composition contains the cerium oxide in an amount of about 99.9 wt % to about 50 wt %. In certain embodiments, the particulate oxide composition contains the cerium oxide in an amount of about 99.5 wt % to about 25 wt % or in an amount of about 99 wt % to about 30 wt % based on the total weight of the particulate oxide composition. In particular embodiments, the particulate oxide composition contains the cerium oxide in an amount of about 98 wt % to about 65 wt % or in an amount of about 98 wt % to about 70 wt % based on the total weight of the particulate oxide composition. In additional embodiments, the particulate oxide composition contains the cerium oxide in an amount of about 98 wt % to about 75 wt % or in an amount of about 95 wt % to about 80 wt % based on the total weight of the particulate oxide composition. In specific of these embodiments, the particulate oxide composition contains the cerium oxide in an amount of about 85 wt % based on the total weight of the particulate oxide composition. The amount of cerium oxide will vary with and correspond to the amount of trivalent dopant, and any amount of optional additional metal oxide, so that the total amount is about 100% of the particulate composition.

In specific embodiments, the particulate oxide composition comprises about zero wt % additional metal oxides, and in these embodiments, the particulate oxide composition comprises the cerium oxide in an amount to provide about 100% of the particulate composition based on the weight % of trivalent dopant. For example, in embodiments containing the trivalent dopant in an amount of about 0.1 wt % up to about 50 wt % based on the total weight of the particulate oxide composition, the composition contains cerium oxide in an amount of about 99.9 wt % to about 50 wt %. In an embodiment containing the trivalent dopant in an amount of about 1 wt % to about 40 wt % based on the total weight of the particulate oxide composition, the composition contains cerium oxide in an amount of about 99 wt % to about 60 wt %. In an embodiment containing the trivalent dopant in an amount of about 2 wt % to about 30 wt % based on the total weight of the particulate oxide composition, the composition contains cerium oxide in an amount of about 98 wt % to about 70 wt %, and the like.

As described herein, the particulate oxide composition optionally may contain additional metal oxides other than the cerium oxide and trivalent dopant. These additional metal oxides may be selected from the group consisting of aluminum (Al), titanium (Ti), zirconium (Zr), hafnium (Hf), and mixtures thereof. The particulate oxide composition as disclosed herein generally comprises the additional metal oxide in an amount of about 70 wt % to about 0 wt % based on the total weight of the particulate oxide composition.

In certain embodiments, the particulate oxide comprises cerium oxide in an amount of about 99.9 wt % to about 20 wt % based on the total weight of the particulate oxide composition; trivalent dopant in an amount of about 0.1 wt % up to about 50 wt % based on the total weight of the particulate oxide composition; and additional metal oxide in an amount of about 70 wt % to about 0 wt % based on the total weight of the particulate oxide composition. In the particulate oxide composition, the cerium oxide is present in an amount greater than trivalent dopant.

When additional metal oxides are present, the particulate oxide composition generally comprises these additional metal oxides in an amount of about 70 wt % to about 0.1 wt % based on the total weight of the particulate oxide composition. In certain embodiments, the particulate oxide composition contains these additional metal oxides in an amount of about 50 wt % to about 0.1 wt % or in an amount of about 30 wt % to about 0.1 wt % based on the total weight of the particulate oxide composition. In certain embodiments, the particulate oxide composition contains these additional metal oxides in an amount of about 10 wt % to about 0.1 wt % based on the total weight of the particulate oxide composition. In other embodiments, the particulate oxide composition contains about zero wt % additional metal oxides. The amount of additional metal oxide will vary with and correspond to the amount of trivalent dopant and cerium oxide so that the total amount is about 100% of the particulate composition.

In one embodiment, the particulate oxide composition comprises trivalent dopant in an amount of about 2 wt % to about 25 wt % based on the total weight of the particulate oxide; cerium oxide in an amount of about 20 wt % to about 30 wt %; and additional metal oxide in an amount of about 45 wt % to about 78 wt %. In the particulate oxide compositions, the cerium oxide is present in an amount greater than trivalent dopant and the amounts of the components will vary and correspond so that the total amount is about 100% of the particulate composition.

In an alternative embodiment, the particulate oxide composition comprises trivalent dopant in an amount of about 2 wt % to about 25 wt % based on the total weight of the particulate oxide; cerium oxide in an amount of about 45 wt % to about 78 wt %; and additional metal oxide in an amount of about 20 wt % to about 30 wt %. In the particulate oxide compositions, the cerium oxide is present in an amount greater than trivalent dopant and the amounts of the components will vary and correspond so that the total amount is about 100% of the particulate composition.

The particulate oxide composition optionally may further contain impurities in a minor amount. These impurities are typically present in an amount of about 1% by weight or less (to about zero or to an amount that is undetectable) based on the total weight of the particulate oxide composition. These impurities include residual solvents, salts, other metals, and the like. These other metals include those commonly found in water, such as magnesium, iron, calcium, silicon, sodium, and the like. These impurity amounts (of about 1% by weight to about zero or to an amount that is undetectable) may be present in any of the above and below described embodiments of the particulate oxide compositions. When present and detectable, any impurities are generally present in an amount of about 100 ppm or less.

The particulate oxide compositions as disclosed herein have a unique depth profile for the distribution of the cerium oxide and the trivalent dopant. This unique depth profile means that there is a higher ratio of trivalent dopant to Ce closer to the surface of the particulate oxide composition in comparison to deeper within the particulate oxide composition. Without wishing to be bound by any theory, the unique depth profile for the particulate oxide compositions provides unique structural (i.e., physical) and electrochemical properties and provides improved activity for removing biological contaminants when used in the blended compositions as disclosed herein.

With regard to the depth profile, one of skill in the art recognizes that these particulate oxide compositions have a surface, and this surface is referred to as at about 0 nm. One of skill in the art understands how to measure the Ce and trivalent dopant from this surface (i.e., at 0 nm) to depths (measured in nm) within the particulate oxide composition and from this measurement can calculate trivalent dopant to Ce ratios and an average trivalent dopant to Ce ratio at different depths.

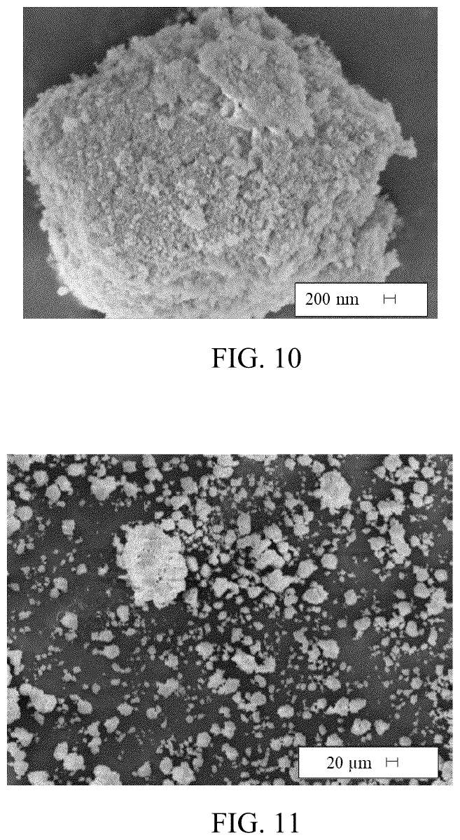

The unique depth profile of the particulate oxide composition is characterized such that the average trivalent dopant to Ce ratio at about 0 nm (i.e., the surface) to about 3.5 nm from the surface of the particulate oxide composition is greater than the trivalent dopant to Ce ratio at about 15 nm from the surface of the particulate oxide composition. Measurements of the Ce and trivalent dopant are taken at certain intervals from 0 nm (i.e., the surface) to about 3.5 nm and then averaged. Measurement of the Ce and trivalent dopant is also taken at about 15 nm from the surface of the particulate composition. FIG. 8 is a graph of the ratio of LaO⁺/CeO⁺ vs depth and demonstrates this unique depth profile for one example of particulate oxide composition to be used within the blended compositions.

The depth profile for the distribution of cerium oxide and trivalent dopant is measured by Time of Flight (ToF) Secondary Ion Mass Spectrometry (SIMS) Depth profilometry as described in Noël, C. et al. ToF-SIMS Depth Profiling of Organic Delta Layers with Low-Energy Cesium Ions: Depth Resolution Assessment, Journal of The American Society for Mass Spectrometry, Vol. 30 (2019) pp 1537-1544, the contents of which are incorporated by reference in their entirety. As one of skill in the art understands, a square section of a particle of the sample material is chosen and analyzed by ToF-SIMS which yields the analysis at a depth of 0 nm (i.e., at the surface). ToF-SIMS works by bombarding the target material with an ion beam, which causes the material to sputter. Sputtering is a phenomenon where microscopic particles are ejected from the surface of a solid material. The ejected particles are then analyzed by mass in the mass spectrometer. The ion source for the ToF-SIMS analysis in this disclosure was a cesium ion source run at 2 keV with a target current of 130 nA; the sputtering size was 500 μm²; the analysis area was 200 μm², 2 frames analysis followed by 6 frames sputter, and 60 seconds sputter time. The selected square section is then etched with an ion beam to remove the surface atoms. In this disclosure, a primary ion beam was a bismuth liquid metal ion gun run at 30 keV with pulsed target current of approximately 0.6 pA; the sputtering size was 250 μm²; the analysis area was 100 μm², 2 frames analysis followed by 50 frames sputter, and 20,000 seconds sputter time. The time of the etching is correlated to the depth of the etching, and thus the depth can be controlled. In this disclosure, the sputter depth was calibrated to 1 nm/s. The exposed surface is then reanalyzed by ToF-SIMS to give the analysis at the new depth. The particulate composition can be analyzed in any increments of nm, for example, in increments of about 0.2 nm, increments of about 0.5 nm, increments of about 1 nm, and the like. This process is repeated until the desired depth is obtained. The observed mass spectrometry data is then correlated to the depth at which it was collected. For the present disclosure, it is important to determine the ratio of trivalent dopant to Ce, and thus, this is the reported data.

In one embodiment, the particulate oxide composition of the blended composition comprises cerium oxide, trivalent dopant (as an oxide) selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate oxide composition. In one embodiment of this particulate oxide composition, the composition comprises about 0.1 wt % up to about 50 wt % trivalent dopant. In a certain embodiment, the composition further comprises about 99.9 wt % to about 50 wt % cerium oxide based on the total weight of the particulate oxide composition.

Another embodiment disclosed herein is a particulate oxide composition comprising cerium oxide and trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant, wherein the average trivalent dopant to Ce ratio at about 0 nm to about 3.5 nm from the surface of the particulate composition is greater than the trivalent dopant to Ce ratio at about 15 nm from the surface of the particulate oxide composition, and wherein the composition comprises about 2 wt % to about 30 wt % trivalent dopant. In one embodiment of this particulate oxide composition, the composition comprises cerium oxide in an amount of about 98 wt % to about 70 wt % based on the total weight of the particulate oxide composition.

It can be appreciated that the particulate oxide compositions containing trivalent doped CeO₂ having the described depth profile can have any of the above-described amounts of trivalent dopant, cerium oxide, and optional additional metal oxide.

In particular embodiments, the particulate oxide composition contains cerium oxide and trivalent dopant with only minor amounts to no (i.e., about zero) additional metal oxides and only 1% to no (i.e., zero or undetectable) amounts of impurities. When present and detectable, any impurities are generally present in an amount of about 100 ppm or less.

In certain embodiments, the particulate oxide compositions have an average trivalent dopant to Ce ratio at about 0 nm to about 3.5 nm from the surface of the particulate oxide composition that is about 10% to about 250% greater than the trivalent dopant to Ce ratio at about 15 nm from the surface of the particulate oxide composition. In other embodiments, the particulate oxide compositions have an average trivalent dopant to Ce ratio at about 0 nm to about 3.5 nm from the surface of the particulate oxide composition that is about 15% to about 250% greater than the trivalent dopant to Ce ratio at about 15 nm from the surface of the particulate oxide composition. As stated above, it is understood that 0 nm from the surface of the particulate oxide composition is the surface of the particulate oxide composition.

It can be appreciated that the particulate oxide compositions containing trivalent doped CeO₂ having the above-described depth profile also can have any of the above-described amounts of trivalent dopant, cerium oxide, and optional additional metal oxide, and the below described additional properties.

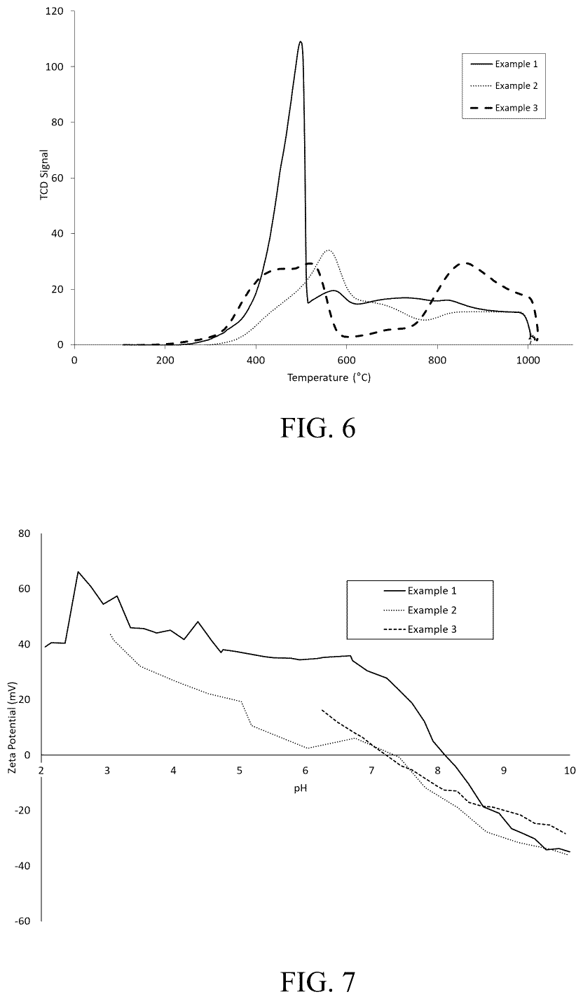

The particulate oxide compositions containing trivalent doped CeO₂ having the unique depth profile also can exhibit unique physical characteristics, including for example, exhibiting both physisorption and chemisorption of CO₂ (see FIGS. 5A, 5B, and 5C). Physisorption also is known as physical adsorption and is a weak association, such as through van der Waals. Chemisorption also is known as chemical adsorption. In chemisorption, adsorption takes place, and the adsorbed substance is bound by chemical bonds. This is a much stronger adsorption than physisorption. Exhibiting physisorption and chemisorption is a unique characteristic of the particulate compositions containing trivalent doped CeO₂ having the above-described depth profile. Since the adsorbant is CO₂ (an acid), exhibiting chemisorption indicates the material is more basic and may provide improved activity for removing biological contaminants. This property of exhibiting physisorption and chemisorption may be combined with any of the above-described depth profiles and any of the above-described amounts of trivalent dopant, cerium oxide, and optional additional metal oxide, as well as the below described additional properties.

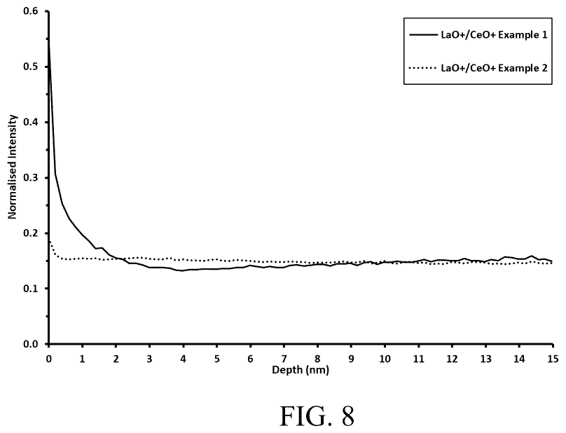

The particulate oxide compositions with the unique depth profile also can be more readily reduced than compositions made by prior art methods, and thus, these compositions are more oxidizing. FIG. 6 is a graph of the temperature program hydrogen reduction of material from Examples 1, 2, and 3. Example 1 has a large sharp peak at a lower temperature. This peak indicates that this novel particulate oxide composition is more easily reduced as compared to the compositions of Example 2 or 3. Thus, the particulate oxide compositions having a unique depth profile can be more oxidizing, and thus, more effective for removing/reducing biological contaminants. The graph for Example 2 has essentially the same shape as Example 1 but it is shifted to higher temperatures, which indicates more energy is needed for the material to react with hydrogen and would thus it would be less oxidizing than Example 1. The graph for Example 3, which is undoped cerium oxide, shows two peaks for hydrogen reduction that are broad and not very tall. This would indicate there are two types of reductions that could take place with this material and the higher temperature one is much more difficult to achieve. Without wishing to be bound by any theory, the unique depth profile for the particulate oxide compositions, such that there is a higher ratio of trivalent dopant to Ce on and closer to the surface of the particulate matter, could lead to this change in hydrogen reduction temperature and more oxidative properties. And these more oxidative properties of the particulate oxide compositions having the unique depth profile can provide improved activity for removing biological contaminants. This property also can be combined with any of the above-described depth profiles, physical properties, and any of the above-described amounts of trivalent dopant, cerium oxide, and optional additional metal oxide, as well as the below described additional properties.

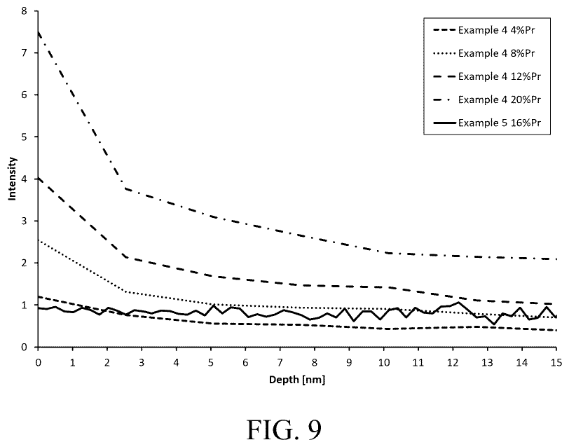

The particulate oxide compositions containing trivalent doped CeO₂ and having the unique depth profile as disclosed herein further can exhibit more basicity as indicated by its isoelectric point and zeta potential (see FIG. 7). In certain embodiments, the particulate oxide composition as described herein has an isoelectric point at a pH of about 8 to about 9. In additional embodiments, the particulate oxide composition as described herein has a zeta potential of about 20 to about 40 mV at a pH of about 7. Having a higher isoelectric point indicates the material is more basic and may provide improved activity for removing biological contaminants. This property also can be combined with any of the above-described depth profiles, physical properties, and any of the above-described amounts of trivalent dopant, cerium oxide, and optional additional metal oxide, as well as the below described additional properties.

The particulate oxide compositions containing trivalent doped CeO₂ also can have a surface area that assists in providing the biological contaminant removal properties.

As described herein, the surface area is the apparent surface area of the compositions as determined by using a Micromeritics ASAP 2000 system and nitrogen at about 77 Kelvin. The procedure outlined in ASTM International test method D 3663-03 (Reapproved 2008) was used but with one significant exception. It is well known that a “BET Surface Area” determination is not possible for materials that contain microporosity. Recognizing that the surface area is an approximation, the values reported are labeled “apparent surface area” values rather than “BET surface area” values. In compliance with commonly accepted procedures, the determination of apparent surface area, the application of the BET equation was limited to the pressure range where the term na(1−P/Po) of the equation continuously increases with P/Po. The out gassing of the sample was done under nitrogen at about 300 degrees Celsius for about 2 hours.

The particulate oxide compositions containing trivalent doped CeO₂ can have a surface area of about 70 m²/g to about 300 m²/g. While not wanting to be bound by any theory, it is believed that the surface area can affect and improve the removal of the biological contaminant from a gaseous or an aqueous stream or by contact with a solid surface.

It can be appreciated that the particulate oxide compositions having this surface area can have the below-described average pore volume in combination with any one or more of the depth profile and the other above-described properties, as well as any of the above-described amounts of trivalent dopant, cerium oxide, and optional additional metal oxide.

The particulate oxide compositions typically have an average (mean, median, and mode) pore volume (as determined by N₂ adsorption) of about 0.01 cm³/g to about 1.5 cm³/g. While not wanting to be bound by any theory it is believed that the average pore volume can affect and improve the removal of the biological contaminant from an aqueous or gaseous stream.

It can be appreciated that the particulate oxide compositions can have the above-described average pore volumes in combination with any one or more of the above surface areas, depth profile, and the other above-described properties, as well as any of the above-described amounts of trivalent dopant, cerium oxide, and optional additional metal oxide.

The particulate oxide compositions containing cerium oxide and one or more trivalent dopants can effectively remove biological contaminants and even more effectively remove biological contaminants when used in the blended compositions with silver zinc zeolite. The blended compositions are capable of removing approximately 90% or more of the biological contaminants. In certain embodiments, the blended compositions are capable of removing approximately 99% or more of the biological contaminants.

The blended compositions as disclosed herein perform better than silver zinc zeolite alone and allow for use of a reduced amount of silver zinc zeolite while maintaining efficacy for removing biological contaminants.

When the two components are used together, the blended compositions allow for reduced amount of the silver zinc zeolite while retaining activity, and the blended compositions tend to exhibit better activity than the silver zinc zeolite or the particulate oxide compositions alone. As such, the blended compositions exhibit unexpected synergistic activity for removing/reducing biological contaminants.

The novel blended compositions contain silver zinc zeolite and particulate oxide compositions, both as described above. The blended compositions comprise the silver zinc zeolite in an amount of about 1 wt % to less than about 50 wt % based on the total weight of the blended composition and the particulate oxide composition in an amount of greater than about 50 wt % to about 99 wt % based on the total weight of the blended composition. In certain embodiments, the blended compositions comprise about 10 wt % to about 25 wt % silver zinc zeolite and about 75 wt % to about 90 wt % particulate oxide composition.

In the blended compositions, the silver zinc zeolite is present in a minority amount in comparison to the particulate oxide composition. The particulate oxide compositions in the blended compositions include all of the embodiments for the particulate oxide composition as described supra. In particular the particulate oxide compositions in the blended compositions are those with the unique depth profile as described herein.

The blended compositions can be slurried with a biological contaminant-containing aqueous stream and effectively remove the biological contaminants. In some embodiments, slurrying the blended compositions with a biological contaminant-containing aqueous stream removes at least about 90% of the biological contaminant. In other embodiments, the slurrying removes at least 95%, or more preferably 99% or 99%+ of the biological contaminant.

The blended compositions as described herein also can be incorporated into supported compositions and/or articles for removing biological contaminants as described infra.

### Supported Compositions and Articles

Also disclosed herein are supported compositions comprising a support material and the blended compositions containing silver zinc zeolite and trivalent doped CeO₂ particulate compositions. These supported compositions are for removing biological contaminants. The supported compositions comprise a support material and the blended compositions containing silver zinc zeolite and particulate oxide composition comprising cerium oxide doped with a trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant.

As described, the particulate oxide composition comprises cerium oxide, one or more trivalent dopants (as oxides), and optionally the additional metal oxides, other than the cerium oxide and trivalent dopant, and/or trace amounts of impurities. In certain embodiments, the particulate oxide composition contains about zero additional metal oxides. The particulate oxide composition has the unique depth profile wherein the cerium oxide is present in amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition. The particulate oxide compositions in the blended compositions within the supported compositions include all of the embodiments for the particulate oxide composition as described supra.

The supported compositions for removing biological contaminants also comprise a support material. This support material comprises an organic polymer, cotton, glass fiber, or mixtures thereof.

The organic polymer can be a homopolymer of organic monomers or a co-polymer. The organic polymer also can be a silicone or polysiloxane (i.e., a polymer made up of siloxane (—R₂Si—O—SiR₂—, where R=organic group)). The organic polymer also can be a thermoset polymer, such as a thermoplastic elastomer. In certain embodiments, the organic polymer is selected from the group consisting of polyethylene, polycarbonate, polyvinyl chloride, nylon, polypropylene, polyester, polyurethane, polyamide, polyolefin, copolymers thereof, and mixtures thereof. In certain embodiments, the organic polymer is silicone.

In the supported compositions as disclosed herein, the blended composition is deposited on or within the support material.

In one embodiment of the supported composition, the particulate oxide composition, of the blended composition, comprises cerium oxide in an amount of about 99.9 wt % to about 20 wt % based on the total weight of the particulate oxide composition; trivalent dopant (as an oxide) in an amount of about 0.1 wt % up to about 50 wt % based on the total weight of the particulate oxide composition; and additional metal oxide in an amount of about 70 wt % to about 0 wt % based on the total weight of the particulate oxide composition.

In another embodiment of this supported composition, the particulate oxide composition, of the blended composition, comprises about 0.1 wt % up to about 50 wt % trivalent dopant and about 99.9 wt % to about 50 wt % cerium oxide based on the total weight of the particulate oxide composition.

In yet another embodiment of this supported composition, the particulate oxide composition, of the blended composition, comprises cerium oxide in an amount of about 20 wt % to about 30 wt % based on the total weight of the particulate oxide composition; trivalent dopant in an amount of about 2 wt % to about 25 wt % based on the total weight of the particulate oxide composition; and additional metal oxide in an amount of about 45 wt % to about 78 wt % based on the total weight of the particulate oxide composition.

In a further embodiment of this supported composition, the particulate oxide composition, of the blended composition, comprises cerium oxide in an amount of about 45 wt % to about 78 wt % based on the total weight of the particulate oxide composition; trivalent dopant in an amount of about 2 wt % to about 25 wt % based on the total weight of the particulate oxide composition; and additional metal oxide in an amount of about 20 wt % to about 30 wt % based on the total weight of the particulate oxide composition.

In these supported compositions, it can be appreciated that the blended compositions can have any of the above-described amounts of particulate oxide composition and silver zinc zeolite.

These supported compositions comprise a support material comprising an organic polymer, cotton, glass fiber, or mixtures thereof and the blended composition containing silver zinc zeolite and particulate oxide composition having the unique depth profile. As described, this particulate oxide composition is a mixed oxide composition (i.e., a mixture of oxides of the cerium, trivalent dopant, and optionally additional metal oxides).

In these supported compositions, the blended composition containing silver zinc zeolite and particulate oxide composition (i.e., the trivalent doped cerium oxide having the unique depth profile) is deposited on or within the support material. The particulate oxide composition of this supported composition includes all of the embodiments as described supra, including all of the properties and any of the above-described amounts of trivalent dopant, cerium oxide, and optional additional metal oxide.

In all embodiments, the supported compositions contain approximately 0.5 to approximately 80 weight % blended composition based on the total weight of the supported composition. In certain embodiments, the supported compositions contain approximately 0.5 to approximately 50 weight % blended composition based on the total weight of the supported composition. In other embodiments, the supported compositions contain approximately 0.5 to approximately 25 weight % blended composition based on the total weight of the supported composition. In yet other embodiments, the supported compositions contain approximately 0.5 to approximately 10 weight % blended composition based on the total weight of the supported composition. In additional embodiments, the supported compositions contain approximately 0.5 to approximately 5 weight % blended composition based on the total weight of the supported composition. In these supported compositions, it can be appreciated that the blended compositions can have any of the above-described amounts of particulate oxide composition and silver zinc zeolite.

The supported composition containing the support material and the blended composition can be in a rigid or elastic form. The supported composition can form an article for removing biological contaminants, such as a filter or a plastic (such as a plastic container). The article can be in a rigid or elastic form.

When the supported composition forms an article, the article contains about 50 to about 100 weight % of the supported composition containing the support material and the blended composition based on the total weight of the article. In certain embodiments, the article contains about 75 to about 95 weight % of the supported composition containing the support material and the blended composition based on the total weight of the article.

When the blended composition and support are formed into an elastic or rigid article, the article also may include binder, sand, gravel, glass wool, a metal or plastic container, and the like.

In some embodiments, the support material can be an organic polymer. In certain of these embodiments, the trivalent dopant of the particulate oxide composition is Pr, La, or a mixture thereof. When this supported composition using an organic polymer as the support material forms an article, the article can be a plastic article. In these embodiments, the organic polymer can be selected from the group consisting of polyethylene, polyvinyl chloride (PVC), nylon, polypropylene, polyester, polyurethane, polyamide, polyolefin, polycarbonate, copolymers thereof, and mixtures thereof. In specific embodiments, the organic polymer is polyethylene, polycarbonate, or mixtures thereof. When a plastic, the article can be in the form of a filter, bottle, container, or a plastic covering for a high touch service. The filter can be a fixed bed. The bottle or container may be for liquids. High touch surfaces include escalator or stair handrail covering, an elevator button covering, a door, a door handle or knob or covering therefore, coverings on public transportation, touch pads for electronic transactions, and the like.

In some embodiments, the support material can be cotton. In certain of these embodiments, the trivalent dopant of the particulate oxide composition is Pr, La, or a mixture thereof. When this supported composition using cotton as the support material forms an article, the article can be a filter or a fabric.

In some embodiments, the support material can be glass fiber. In certain of these embodiments, the trivalent dopant of the particulate oxide composition is Pr, La, or a mixture thereof. When this supported composition using glass fiber as the support material forms an article, the article can be a filter, bottle, container, or high touch surface. The filter can be a fixed bed. High touch surfaces include an elevator button covering, a door, coverings on public transportation, touch pads for electronic transactions, and the like.

In certain embodiments, the support material can be cotton and an organic polymer. In certain of these embodiments, the organic polymer can be selected from the group consisting of nylon, polyester, polyamide, and mixtures thereof. In certain of these embodiments, the trivalent dopant of the particulate oxide composition is Pr, La, or a mixture thereof. When this mixture as the support material forms an article, the article can be a filter or a fabric.

In certain embodiments, the support material can be glass fiber and an organic polymer. The organic polymer can be selected from the group consisting of polyethylene, polyvinyl chloride (PVC), nylon, polypropylene, polyester, polyurethane, polyamide, polyolefin, polycarbonate, copolymers thereof, and mixtures thereof. In certain of these embodiments, the organic polymer can be selected from the group consisting of polyethylene, polycarbonate, and mixtures thereof. In certain of these embodiments, the trivalent dopant of the particulate oxide composition is Pr, La, or a mixture thereof. When this mixture as the support material forms an article, the article can be a filter, bottle, container, or high touch surface. The filter can be a fixed bed. High touch surfaces include escalator or stair handrail covering, an elevator button covering, a door, a door handle or knob covering, coverings on public transportation, touch pads for electronic transactions, and the like.

In some embodiments, the support material can be polyethylene or polycarbonate. In certain of these embodiments, the trivalent dopant of the particulate oxide composition is Pr, La, or a mixture thereof. And when the supported composition forms an article, the article can be a plastic article and can be in the form of a filter, bottle, container, or plastic covering for a high touch surface. The filter can be a fixed bed.

In certain embodiments, the support material can be silicone. In certain of these embodiments, the trivalent dopant of the particulate oxide composition is Pr, La, or a mixture thereof.

In a specific embodiment, the article is a plastic article. The plastic article can be in the form of a filter, bottle, container, or plastic covering for a high touch surface. The plastic article comprises a supported composition for removing biological contaminants comprising (i) an organic polymer selected from the group consisting of polyethylene, polyvinyl chloride, nylon, polypropylene, polyester, polyurethane, polyamide, polyolefin, polycarbonate, copolymers thereof, and mixtures thereof. The plastic article further comprises the blended composition comprising (i) silver zinc zeolite and (ii) particulate oxide composition comprising cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition. In certain of these embodiments, the trivalent dopant of the particulate oxide composition is Pr, La, or a mixture thereof. And in certain of these embodiments of the plastic article, the organic polymer can be selected from the group consisting of polyethylene, polycarbonate, and mixtures thereof.

In all embodiments of the plastic article, the blended composition is deposited on or within the organic polymer. In certain embodiments, the plastic article comprises about 50 to about 100 weight percent of the supported composition for removing biological contaminants based on the total weight of the plastic article.

In certain embodiments of the plastic article, it comprises a blended composition containing (i) silver zinc zeolite and (ii) a particulate oxide composition comprising about 0.1 wt % up to about 50 wt % trivalent dopant and about 99.9 wt % to about 50 wt % cerium oxide based on the total weight of the particulate oxide composition. This specific particulate oxide composition includes all of the embodiments for the particulate oxide composition as described supra.

The blended compositions containing silver zinc zeolite and trivalent doped cerium oxide particulate compositions, the supported compositions, and the articles as disclosed herein are capable of removing approximately 90% or more of the biological contaminants. In certain embodiments, the blended compositions, supported compositions, and articles as disclosed herein are capable of removing approximately 99% or more of the biological contaminants.

The biological contaminants to be removed by the articles, supported compositions, blended compositions, and methods disclosed herein include viruses, bacteria, fungi, (e.g., mold or fungus), protozoa (e.g., amoebae), algae, yeast, and the like, and mixtures thereof. In certain embodiments, the biological contaminants to be removed by the articles, compositions, and methods disclosed herein are selected from the group consisting of bacteria, viruses, fungi (e.g., mold), protozoa (e.g., amoebae), and mixtures thereof. In specific embodiments, the biological contaminants to be removed by the articles, compositions, and methods disclosed herein are bacteria, viruses, amoebae, and mixtures thereof. In other embodiments, the biological contaminants are bacteria, viruses, and mixtures thereof.

In certain embodiments the biological contaminants to be removed include those of concern in aqueous streams, such as wastewater, and those of concern which are airborne.

The bacteria include gram positive and gram negative bacteria. The bacteria include those commonly found in water, including fecal coliform bacteria. The bacteria include, for example, Streptococcus, Staphylococcus, Escherichia coli, Methicillin-resistant Staphylococcus aureus (MRSA), Legionella Pneumophila, Campylobacter Jejuni, Salmonella, Mycobacterium tuberculosis, Corynebacterium diphtheriae, Listeria monocytogenes, Bordetella pertussis, and the like. The viruses include, for example, rhinovirus, coronaviruses, vaccinia, poliovirus, varicella zoster virus, paramyxovirus, influenza virus, morbillivirus, hepatitis A virus (HAV), adenovirus (HAdV), rotavirus (RoV), sapovirus, respiratory syncytial virus (RSV), paramyxovirus, varicella-zoster virus (VZV), variola virus (including smallpox and monkey pox), and other enteric viruses, such as noroviruses (NoV), coxsackievirus, echovirus, reovirus and astrovirus, and the like. Other microbial contaminants include protozoa (such as Cryptosporidium) and specifically amoebae (such as Naegleria fowleri). Further microbial contaminants, which are fungi, include Trichophyton mentagrophytes and Aspergillus.

The articles, compositions, and methods disclosed herein reduce the concentration or amount of these biological contaminants.

### Method of Making the Trivalent Doped Cerium Oxide Particulate Oxide Composition

There are known methods for making trivalent doped cerium oxide compositions (see for example U.S. patent application Ser. No. 17/870,068 entitled “Use of Trivalent Doped Cerium Oxide Compositions for Biological Contaminant Removal” filed Jul. 21, 2021, the contents of which are hereby incorporated by reference in their entirety). The methods for making trivalent doped cerium oxide compositions with the unique depth profile as described herein are described in U.S. patent application Ser. No. 17/895,942, entitled “Trivalent Doped Cerium Oxide Compositions for Biological Contaminant Removal” filed Aug. 25, 2022, the contents of which are hereby incorporated by reference in their entirety.

### Preparing Blended Compositions

The blended compositions as disclosed herein contain the particulate oxide composition and silver zinc zeolite.

The method of making the blended compositions includes physically mixing the silver zinc zeolite with the particulate oxide composition. As an example, the silver zinc zeolite can be mixed with the particulate oxide composition to yield a blended composition. In some embodiments, the blended composition is about 10% wt/wt silver zinc zeolite and about 90% wt/wt particulate oxide composition. The physical mixing can occur by placing the silver zinc zeolite and the particulate oxide composition in a sealed container and then the container is shaken, inverted repeatedly, tumbled, or similar action. Alternatively, the physical mixing can occur by placing silver zinc zeolite and the particulate oxide composition in a device designed to mix dry powder materials, such as a blender, paddle mixer, or the like. In any mixing method, the mixing should occur for an amount of time that achieves a homogeneous mixture of the materials.

### Preparing Supported Compositions and Articles

The supported compositions contain a support material and the blended composition of silver zinc zeolite and particulate oxide composition. The particulate oxide composition comprises the cerium oxide and trivalent dopant and having the unique depth profile as described supra. The particulate oxide composition optionally may comprise the additional metal oxides other than the cerium oxide and trivalent dopant. The particulate oxide composition, blended composition, supported compositions, and articles include all of the embodiments described herein. In the supported composition, the support material is selected from an organic polymer, cotton, glass fiber, or mixtures thereof.

The supported composition independently may be used for treating gaseous or aqueous mixtures. Or the supported composition may be incorporated into an article specifically designed for treating gaseous or aqueous mixtures, such as a filter or a plastic container. The filter may be a fixed bed. The filter may be used for a gaseous or aqueous mixture or stream and thus to filter the gaseous or aqueous mixture or stream.

In supported compositions and in articles containing supported compositions, the blended composition is deposited onto a support material or within the support material to provide the supported composition for removing biological contaminants.

The blended composition can be deposited on one or more external and/or internal surfaces of the support material. It can be appreciated that persons of ordinary skill in the art generally refer to the internal surfaces of the support material as pores. The blended composition as described herein can be supported on the support material with or without a binder. In some embodiments, the blended composition can be applied to the support material using any conventional techniques, such as slurry deposition.

Processes of preparing the supported compositions are not limited by any particular steps or methods, and generally can be any that result in the incorporation of the blended composition into a support material or deposited onto a support material. Processes to incorporate the blended composition into a support material include mixing the blended composition into the support material production. As an example, the blended composition can be added to molten polypropylene in the molding process. As another example, the blended composition can be added to a mixture of polyvinyl chloride resin, a plasticizer, and a stabilizer and passed through a hot mixer followed by an extruder.

Processes to deposit the blended composition onto a support material include mixing the blended composition with an organic binder either as a liquid or in an aqueous solution. The mixture of blended composition and organic binder is then bound to the support material by immersion of the support material or by coating the support material with the mixture by spreading or air brushing. The organic binder also can be used in slurry deposition techniques.

In certain embodiments, the organic binder is selected from the group consisting of citric acid, polyurethane diol, polyvinyl alcohol, polyvinylpyrollidone, linseed oil, and mixtures thereof. Once the blended composition is bound to the support material, the support as coated optionally may be rinsed with water prior to drying to remove residual not bound to the support. The coated support can then be optionally dried at temperatures above about 20° C. and below about 300° C. for about 1-12 hours or until sufficiently dry. In certain embodiments, the coated support can then be optionally dried at temperatures above about 20° C. and below about 120° C.

In the case of support materials that can melt, such as glass or plastics, the support can be heated to the point where the surface just begins to soften, then the blended composition can be placed on the surface such that it begins to mix with the semi-molten material. Upon cooling and resolidifying the blended composition is incorporated into the surface of the support material. The temperature utilized would depend on the support material utilized. One of skill in the art readily would be able to determine the appropriate temperature for the support material being utilized. For example, this temperature for quartz glass would be over 1000° C.; borosilicate glass would be about 500-600° C.; and PVC would be about 200-300° C.

These solid supports can be utilized to form articles including filters and plastic articles.

The blended compositions also may be incorporated into an article for a high touch surface and this high touch surface may come into contact with biological contaminants by direct touch contact. As such, articles for high touch surfaces also may be utilized in reducing bacteria and/or viruses deposited through contact and not necessarily just in treating fluids. These articles may be containers for liquids, elevator buttons, hand railing covers for escalators or stairs, a door, door handle, doorknob, coverings on public transportation, touch pads for electronic transactions, fabrics, and the like.

The supported compositions containing the blended composition and support material can be formed into an elastic or rigid article, such as a filter, a fixed bed filtration system, a bottle or container, a high touch surface, and the like. In specific embodiments the article is a plastic article. In other embodiments, the article is a filter. These articles may contain any additional necessary components that such articles ordinarily contain, as well recognized by those of skill in the art. Techniques for forming these articles are well known to those of skill in the art.

### Methods for Using the Blended Compositions

The present application relates to methods for removing biological contaminants using any of the above disclosed compositions containing the blended composition of the trivalent doped cerium oxide and silver zinc zeolite. The methods can utilize the blended compositions per se, or the methods can utilize the blended compositions as part of a supported composition or an article. The methods can treat a fluid, including air and aqueous and gaseous streams.

Without wishing to be bound by any theory, the unique depth profile for the particulate oxide compositions (such that there is a higher ratio of trivalent dopant to cerium on and closer to the surface of the particulate composition) within the blended composition may provide improved activity for removing biological contaminants. Surprisingly, the blended composition has a higher activity than the silver zinc zeolite alone or the particulate oxide compositions alone.

In some embodiments, supported compositions comprising the blended composition and support material may be used independently in methods for removing biological contaminants, or the supported compositions of the blended composition and support material may be incorporated into an article specifically designed for treating gaseous or aqueous mixtures, such as a filter or a plastic (such as a plastic container).

As described herein, within the blended composition, the particulate oxide compositions comprise cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition. It can be appreciated that in these methods, the particulate oxide compositions can have any of the above-described amounts of trivalent dopant, cerium oxide, and optional additional metal oxide, and any of the above-described properties and the blended compositions can have any of the above-described amounts of silver zinc zeolite and particulate oxide composition.

In certain embodiments of the methods, the present application relates to methods for removing and ensuring a target concentration or less of biological contaminants using the disclosed blended compositions containing silver zinc zeolite and trivalent doped cerium oxide. These biological contaminants include bacteria, viruses, protozoa (e.g., amoebae), fungi, algae, yeast, and the like. These methods can use the blended compositions per se, supported compositions containing the blended compositions, and articles containing supported compositions containing the blended compositions.

The methods may treat fluids (e.g., an aqueous stream, gaseous stream, or mixture thereof) or surfaces of solid objects through touch/direct contact. As such, the methods disclosed herein include methods for treating fluids (e.g., aqueous and/or gaseous streams).

In certain embodiments of the methods, an aqueous or gaseous stream is contacted with the blended composition of silver zinc zeolite and the particulate oxide compositions. The particulate oxide compositions include all of the embodiments described supra, including any of the above-described amounts of trivalent dopant, cerium oxide, and optional additional metal oxide, and any of the above-described properties.

In other embodiments of the methods, an aqueous or gaseous stream is contacted with the supported compositions containing the blended compositions as described herein. In yet other embodiments of the methods, a potentially contaminated surface is contacted with the supported compositions or articles containing the blended compositions as described herein. These potentially contaminated surfaces include, for example, skin (e.g., a hand, finger, palm, etc.) and the contact is through touching the supported compositions or articles containing the blended compositions as described herein. In the methods as disclosed, the biological contaminant to be removed may be contained within an aqueous or gaseous stream or may be on the surface of the physical object.

While not wanting to be bound by any theory, it is believed that the contacting of the blended composition containing silver zinc zeolite and particulate oxide composition as described herein with the biological contaminant leads to the biological contaminant one or more of sorbing and/or reacting with the silver zinc zeolite and/or trivalent doped cerium oxide or deactivating when contacted with the silver zinc zeolite and/or trivalent doped cerium oxide. The sorbing, reacting, and/or deactivating of the biological contaminant with the silver zinc zeolite and/or trivalent doped cerium oxide removes the biological contaminant from the biological contaminant-containing fluid (air or aqueous stream) or the solid surface. Without wishing to be bound by any theory, the unique depth profile for the particulate oxide compositions such that there is a higher ratio of trivalent dopant to cerium on and closer to the surface may provide improved activity for removing biological contaminants. It is surprising that the blended compositions exhibit improved activity in comparison to the silver zinc zeolite or the particulate oxide compositions alone.

The biological contaminant may be removed to a target level or to below a target level. In some embodiments the biological contaminant may be removed to a level at which it is undetectable. The target level may be a specified amount or the limit of detection. As part of the methods described herein, the biological contaminant to be removed may be identified and the target amount or level for the contaminant may be set. For certain of the biological contaminants contemplated herein, the target amount or level would be any detectable amount. The methods optionally may additionally comprise monitoring the treated stream for the contaminant.

The methods disclosed herein may be used to treat air or water or may be used to treat contaminants through contact by touch. When used to treat contaminants by contact through touch, the disclosed blended compositions are incorporated into a high touch surface.

Using the disclosed blended compositions to treat biological contaminated air and/or water allows for the efficient operation of air and/or water treatment methods and provides a treated stream with reduced concentrations of biological contaminant. As disclosed herein, the blended compositions may be incorporated into a supported composition and those supported composition may be incorporated into an article specifically designed for treating gaseous or aqueous mixtures, such as a filter, a fixed bed filtration system, or in a plastic for a container. In methods of treating aqueous streams, the blended compositions also may be used per se and contacted through slurrying. In these methods involving slurrying, the method may further comprise filtering the fluid/liquid.

In any of these methods, the particulate oxide compositions within the blended compositions can have any of the above-described amounts of trivalent dopant, cerium oxide, and optional additional metal oxide, and any of the above-described properties. The particulate oxides compositions within the blended composition have the unique depth profile. And the blended compositions can have any of the above-described amounts of silver zine zeolite and particulate oxide compositions.

Although the methods of the disclosure are envisioned for removing biological (e.g., bacterial, viral, amoebae, etc.) contaminants from air and/or drinking water and groundwater, it will be understood that the process can be used to treat any gaseous or aqueous liquid feed that contains undesirable amounts of biological contaminants. The methods also are envisioned for removing biological contaminants through direct contact of a contaminated surface with an article containing the blended compositions as disclosed herein.

In certain embodiments, these methods of removing biological contaminants comprise (i) providing a blended composition comprising (a) silver zinc zeolite and (b) particulate oxide composition comprising cerium oxide; trivalent dopant selected from the group consisting of yttrium (Y), lanthanum (La), neodymium (Nd), praseodymium (Pr), and mixtures thereof; and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition; (ii) contacting the blended composition with a biological contaminant wherein the biological contaminant is selected from the group consisting of bacteria, viruses, fungi, protozoa, and mixtures thereof; and (iii) removing biological contaminant through contact with the blended composition. The biological contaminant can be contained in an aqueous or liquid stream or on the surface of an object that is physically contacted with the blended composition. These methods remove at least about 90% of the biological contaminant through contact with the blended composition.

In some embodiments, the blended composition may be contained within a supported composition and in certain of these embodiments, the supported composition may be incorporated into an article. These methods may further comprise monitoring for the biological contaminant after contacting. The monitoring may be done by sampling or may be continuous.

In certain embodiments, these methods comprise (i) providing a supported composition comprising a support material comprising an organic polymer, cotton, glass fiber, or mixtures thereof and a blended composition, wherein the blended composition comprises (a) silver zinc zeolite and (b) particulate oxide composition comprising cerium oxide, trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition; (ii) contacting the supported composition with a biological contaminant wherein the biological contaminant is selected from the group consisting of bacteria, viruses, fungi (e.g., mold), protozoa (e.g., amoebae), and mixtures thereof; and (iii) removing the biological contaminant through contact with the supported composition. These methods remove at least about 90% of the biological contaminant.

In certain of these methods, the particulate oxide composition within the blended composition comprises cerium oxide in an amount of about 99.9 wt % to about 20 wt % based on the total weight of the particulate oxide composition; trivalent dopant in an amount of about 0.1 wt % up to about 50 wt % based on the total weight of the particulate oxide composition; and additional metal oxide in an amount of about 70 wt % to about 0 wt % based on the total weight of the particulate oxide composition.

The biological contaminant can be contained in an aqueous or liquid stream or on the surface of an object that is physically contacted with the supported composition. These methods may further comprise monitoring for the biological contaminant after contacting. The monitoring may be done by sampling or may be continuous.

The blended compositions include any of the above-described amounts of silver zinc zeolite and particulate oxide composition, and the particulate oxide compositions as used include all of the embodiments as described supra, including any of the above-described amounts of trivalent dopant, cerium oxide, and optional additional metal oxide, and any of the above-described properties. The particulate compositions having the unique depth profile are particularly capable of reducing the concentration of biological contaminants in combination with the silver zinc zeolites.

The contacting of the blended composition with the biological contaminant leads to removal of a measurable amount of the biological contaminant. In some embodiments, the contacting removes at least about 90% of the biological contaminant. In other embodiments, the contacting removes at least 95%, or more preferably 99% or 99%+ of the biological contaminant.

Contacting of the blended composition with biological contaminant effectively reduces the amount of biological contaminant, and in certain embodiments, it effectively reduces the amount of biological contaminant in a gaseous or aqueous stream. The removal also can be expressed as a percent reduction in concentration of the biological contaminant. In some embodiments, the contacting of the blended composition with the biological contaminant can reduce its concentration by more than about 75%. More typically, the contacting of the blended composition with the biological contaminant can reduce its concentration by more than about 80%, more typically more than about 85%, more typically more than about 90%, more typically more than about 95%, more typically more than about 97.5%, more typically more than about 99%, and even more typically more than about 99.5%.

In specific embodiments, these methods may be for removing biological contaminants from fluid or for treating fluid. In these embodiments, the fluid may be a gaseous, aqueous stream, or mixture thereof. In these embodiments, the methods may use either the blended compositions per se, a supported composition, or an article as described herein. As such, the methods comprise (i) providing a blended composition, supported composition, or article as described herein. If in a supported composition, the support material comprises an organic polymer, cotton, glass fiber, or mixtures thereof. The blended composition comprises (a) silver zinc zeolite and (b) particulate oxide composition comprising: cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition. The method further comprises (ii) contacting a biological contaminant containing gaseous or aqueous stream with the blended composition, wherein the biological contaminant is selected from the group consisting of bacteria, viruses, fungi (e.g., mold), protozoa (e.g., amoebae), and mixtures thereof, and (iii) removing biological contaminant from the gaseous or aqueous stream through contact with the blended composition. The biological contaminant can be removed in an amount of 90% or more. These methods may further comprise monitoring for the biological contaminant after contacting. The monitoring may be done by sampling or may be continuous.

In these methods, the blended composition and the particulate oxide compositions within the blended composition include all of the embodiments as described supra. The particulate oxide compositions in combination with the silver zinc zeolites are capable of reducing the concentration of biological contaminants.

In these methods of treating a gaseous or aqueous stream, the method may further comprise a step of setting a target concentration of biological contaminant. In these methods a biological contaminant of interest is identified and then a target concentration for that biological contaminant is set. The methods additionally may comprise a step of monitoring the biological contaminant in the treated stream. The monitoring may be done by sampling or may be continuous.

In certain embodiments, the methods comprise the steps of (i) providing a composition comprising a support material comprising an organic polymer, cotton, glass fiber, or mixtures thereof and particulate oxide composition comprising cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition; (ii) setting a target concentration of a biological contaminant; (iii) contacting a gaseous or aqueous stream with the composition, and removing biological contaminant through contact with the composition to provide a treated stream; and (iv) monitoring the treated stream for the biological contaminant, wherein the biological contaminant is selected from the group consisting of bacteria, viruses, fungi (e.g., mold), protozoa (e.g., amoebae), and mixtures thereof. The particulate oxide compositions as used in these methods include all of the embodiments as described supra. The target concentration can be set at a certain amount of contaminant (e.g., virus, bacteria, protozoa/amoebae, or fungi) or can be set at the limit of detection. Monitoring of the biological contaminant can be performed through techniques well known to those of skill in the art. The monitoring may be done by sampling or may be continuous. One of skill in the art understands real-time and continuous monitoring techniques for microbial contaminants, including viruses, bacteria, protozoa/amoebae, fungi, and the like. These techniques include optical techniques and cell counters.

In specific embodiments of treating an aqueous stream, the methods comprise (i) providing a blended composition comprising (a) silver zinc zeolite and (b) particulate composition comprising cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition; (ii) contacting the aqueous stream with the blended composition and removing biological contaminant through contact with the blended composition to provide a treated aqueous stream, wherein the biological contaminant is selected from the group consisting of bacteria, viruses, fungi (e.g., mold), protozoa (e.g., amoebae), and mixtures thereof. These methods may further comprise monitoring for the biological contaminant after contacting. The monitoring may be done by sampling or may be continuous. In specific embodiments the methods may further comprise setting a target concentration of a biological contaminant and monitoring the treated aqueous stream for the biological contaminant. The target concentration may be a specified amount or the limit of detection. In these methods, the blended composition may be contained within a supported composition or within a supported composition within an article or may be contacted by slurrying the blended compositionper se with the aqueous stream. In methods involving slurrying, the method may further comprise filtering the fluid/liquid. The blended composition and the particulate oxide composition within the blended composition as used in these methods include all of the embodiments as described supra.

In specific embodiments of treating an aqueous stream, the methods comprise (i) providing a supported composition comprising a support material comprising an organic polymer, cotton, glass fiber, or mixtures thereof and a blended composition comprising (a) silver zinc zeolite and (b) particulate composition comprising cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition; (ii) contacting the aqueous stream with the blended composition and removing biological contaminant through contact with the blended composition to provide a treated aqueous stream, wherein the biological contaminant is selected from the group consisting of bacteria, viruses, fungi (e.g., mold), protozoa (e.g., amoebae), and mixtures thereof. The blended compositions and particulate oxide compositions as used in these methods include all of the embodiments as described supra. These methods may further comprise monitoring for the biological contaminant after contacting. The monitoring may be done by sampling or may be continuous. In specific embodiments the methods may further comprise setting a target concentration of a biological contaminant and monitoring the treated aqueous stream for the biological contaminant. The target concentration may be a specified amount or the limit of detection.

In specific embodiments of treating a gaseous stream, the methods comprise the methods comprise (i) providing a supported composition comprising a support material comprising an organic polymer, cotton, glass fiber, or mixtures thereof and a blended composition comprising (a) silver zinc zeolite and (b) particulate composition comprising cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition; (ii) contacting the gaseous stream with the blended composition and removing biological contaminant through contact with the blended composition to provide a treated gaseous stream, wherein the biological contaminant is selected from the group consisting of bacteria, viruses, fungi (e.g., mold), protozoa (e.g., amoebae), and mixtures thereof. The blended compositions and particulate oxide compositions as used in these methods include all of the embodiments as described supra. These methods may further comprise monitoring for the biological contaminant after contacting. The monitoring may be done by sampling or may be continuous. In specific embodiments the methods may further comprise setting a target concentration of a biological contaminant and monitoring the treated gaseous stream for the biological contaminant. The target concentration may be a specified amount or the limit of detection.

When the biological contaminant is bacteria or fungi/mold, the removal can be expressed as a % reduction that is determined by using Colony Forming Units (CFU). In these embodiments, the concentration of bacteria contaminant after contacting with the blended composition or a supported composition or article comprising the blended composition can be about 45 colony forming units CFU/ml to 5×10⁵ CFU/ml.

When the biological contaminant is bacteria and/or viruses, the removal can be expressed as a % reduction that is determined by using Most Probable Number (MPN) technique. Most Probable Number (MPN) is used to estimate the concentration of viable microorganisms in a sample by means of replicating liquid broth growth in ten-fold dilutions.

A target concentration for biological contaminant also can be set as a percentage reduction of the contaminant from prior to the method and then after contact in the method. In certain embodiments, this percent reduction can be about 75% to about 100% less. In other embodiments, this percent reduction can be about 80% to about 99.9%.

A target concentration for biological contaminant can be set at a limit of detection for that contaminant. As described above, in embodiments including setting a target concentration for biological contaminant, the methods may further comprise one or more of the following additional steps: identifying the biological contaminant of interest; setting the target concentration; and monitoring for the biological contaminant after the contacting step to determine or verify that the biological contaminant is below the target concentration. Depending on the biological contaminant, the target concentration can be any detectable amount of that contaminant and the methods as disclosed herein are effective in treating the aqueous or gaseous stream as long as no amount of that contaminant is detected in the treated stream.

In specific of these embodiments, the stream to be treated can be an aqueous stream and the targeted contaminant can be bacteria, virus, or protozoa (e.g., amoebae). For example, the stream to be treated is an aqueous or gaseous stream and the targeted contaminant can be E. coli, poliovirus, coronavirus, Naegleria fowleri, paramyxovirus, Mycobacterium tuberculosis, Legionella pneumophila, coronavirus, or a mixture thereof. In certain embodiments, the stream to be treated is an aqueous stream and the targeted contaminant is E. coli, poliovirus, Naegleria fowleri, Legionella pneumophila, coronavirus, or a mixture thereof. In certain embodiments, the stream to be treated is a gaseous stream and the targeted contaminant is paramyxovirus, Mycobacterium tuberculosis, coronavirus, or a mixture thereof. In certain embodiments, the viruses to be targeted are transmitted primarily by touch and include varicella-zoster virus (VZV), variola virus (including smallpox and monkey pox).

These specific methods comprise the steps of (i) providing a blended composition comprising: (a) silver zinc zeolite and (b) particulate oxide composition comprising cerium oxide; trivalent dopant selected from the group consisting of yttrium (Y), lanthanum (La), neodymium (Nd), praseodymium (Pr), and mixtures thereof, and optionally an additional metal oxide selected from the group consisting of aluminum (Al), titanium (Ti), zirconium (Zr), hafnium (Hf), and mixtures thereof, wherein the cerium oxide is present in an amount greater than the trivalent dopant and wherein the average trivalent dopant to Ce ratio at about 0 nm to about 3.5 nm from the surface of the particulate composition is greater than the trivalent dopant to Ce ratio at about 15 nm from the surface of the particulate composition; (ii) setting a target concentration of a biological contaminant wherein the contaminant is selected from the group consisting of E. coli, poliovirus, coronavirus, Naegleria fowleri, paramyxovirus, Mycobacterium tuberculosis, Legionella pneumophila, coronavirus or a mixture thereof; (iii) contacting a gaseous or aqueous stream with the blended composition, and removing biological contaminant through contact with the blended composition to provide a treated stream; and (iv) monitoring the treated stream for the biological contaminant. The target concentration can be set at a certain amount of contaminant or can be set at the limit of detection. The method also can include a step of identifying the contaminant of interest prior to setting the target concentration.

The blended compositions and particulate oxide compositions as used in this method include all of the embodiments as described supra. The blended composition of step (i) also can be provided as part of a supported composition, and as such, further comprise a support material comprising an organic polymer, cotton, glass fiber, or mixtures thereof or as part of an article comprising a supported composition.

Examples of gaseous feeds that can be treated according to the methods as disclosed herein include, among others, building ventilation systems, aircraft or vehicle ventilation systems, and ambient room air. Examples of liquid feeds that can be treated according to the methods as disclosed herein include, among others, tap water, well water, surface waters, such as water from lakes, ponds and wetlands, waters for recreational activities, agricultural waters, wastewater from industrial processes, and geothermal fluids. Examples of other uses involving physical contact with biological contaminants rather than filter, include incorporation into a plastic for a container or a plastic to be incorporated into a high touch surface, such as elevator buttons, escalator railing covers, stair railing covers, touch pads for electronic transactions, doors, doorknobs, and the like. These high touch surfaces also may include glass or a mixture of glass and plastic.

The blended compositions can remove bacteria, viruses, protozoa (e.g., amoebae), fungi (e.g., mold), and other microbial contaminants, and in some embodiments remove the bacteria, viruses, protozoa (e.g., amoebae), fungi (e.g., mold), and mixtures thereof from a gaseous or liquid feed.

In one embodiment, the process is envisioned for removing biological contaminants from a gaseous or an aqueous stream using the blended compositions comprising silver zinc zeolite and particulate oxide compositions. The gaseous stream can be one or more of an ambient air source or more supply air for a ventilation system that contains or may contain undesirable amounts of biological and/or other contaminants. The aqueous stream can be one or more of a drinking water and groundwater source that contains or may contain undesirable amounts of biological and/or other contaminants. Furthermore, the aqueous stream can include without limitation well waters, surface waters (such as water from lakes, ponds, and wetlands, including natural and man-made and water for recreational purposes), agricultural waters, wastewater from industrial processes, and geothermal waters.

In some embodiments, the biological contaminant-containing gaseous stream is passed through an inlet into a vessel at a temperature and pressure, usually at ambient temperature and pressure, such that the gas in the biological contaminant-containing gaseous stream remains in the gaseous state. In this vessel the biological contaminant-containing gaseous stream is contacted with the blended composition. The contacting of the blended composition with the biological contaminant-containing gaseous stream removes the biological contaminant. The contacting of the blended composition with the biological contaminant-containing gaseous stream leads to removal of a measurable amount of the biological contaminant and in some embodiments removal of at least 90%, more preferably 95%, and even more preferably 99% or 99%+ of the biological contaminant. The blended compositions and particulate oxide compositions as used in these methods including all of the embodiments as described supra.

In some embodiments, the biological contaminant-containing aqueous stream is passed through an inlet into a vessel at a temperature and pressure, usually at ambient temperature and pressure, such that the water in the biological contaminant-containing aqueous stream remains in the liquid state. In this vessel the biological contaminant-containing aqueous stream is contacted with the blended composition. The contacting of the blended composition with the biological contaminant-containing aqueous stream leads to removal of a measurable amount of the biological contaminant and in some embodiments removal of at least 90%, more preferably 95%, and even more preferably 99% or 99%+ of the biological contaminant. The blended compositions and particulate oxide compositions as used in these methods including all of the embodiments as described supra.

In some embodiments, the blended composition is in the form of a fixed bed. Moreover, the fixed bed containing the blended composition normally comprises particles containing the trivalent doped cerium oxide and particles of silver zinc zeolite. The blended composition can have a shape and/or form that exposes a maximum trivalent doped cerium oxide particle surface area to the gaseous or aqueous fluid with minimal back-pressure and the flow of the gaseous or aqueous fluid through the fixed bed. If desired, the blended composition may be in the form of a shaped body such as beads, extrudates, porous polymeric structures or monoliths. The blended composition can be supported as a layer and/or coating on such beads, extrudates, porous polymeric structures or monolith supports.

Contacting of the blended composition with a biological contaminant-containing fluid normally takes place at a temperature from about 1° C. to about 100° C., more normally from about 5° C. to about 40° C. Furthermore, the contacting of blended composition with a biological contaminant-containing aqueous stream commonly takes place at a pH from about pH 1 to about pH 11, more commonly from about pH 3 to about pH 9. The contacting of the blended composition with biological contaminant-containing fluid generally occurs over a period of time of more than about 30 seconds and no more than about 24 hours.

Generally, the blended compositions can be used to treat any biological contaminant, and in particular bacteria, viruses, protozoa (e.g., amoebae), fungi, yeast, and mixtures thereof.

Contacting of the blended compositions with a gaseous or aqueous stream containing the biological contaminant effectively can reduce the biological contaminant level in the gaseous or aqueous stream. Typically, the contacting of the blended composition with the biological contaminant can reduce its concentration by more than about 75%. More typically, the contacting of the blended composition with the biological contaminant can reduce its concentration by more than about 80%, more typically more than about 85%, more typically more than about 90%, more typically more than about 95%, more typically more than about 97.5%, more typically more than about 99%, and even more typically more than about 99.5%. When the biological contaminant is bacteria or mold, the % reduction can be determined by number using Colony Forming Units (CFU). When the biological contaminant is bacterial or viruses, the % reduction can be determined by Most Probable Number (MPN).

The method of treating air or water to remove biological contaminants comprises the steps of passing an air or water stream containing a first concentration of one or more undesired biological contaminants through a material, article, or supported composition comprising the blended composition and obtaining a treated air or water stream having a concentration of one or more undesired biological contaminants less than the first concentration.

In certain embodiments, the biological contaminants to be removed are viruses. After contacting with the article or supported composition comprising the blended composition, the concentration of virus can be equal to or less than a target concentration of virus. When an air or gaseous stream is to be treated, the contacted (or treated) stream has a concentration of virus equal to or less than a target concentration of virus. In particular of these embodiments, the viruses are coronavirus.

In certain embodiments, the biological contaminants to be removed are bacteria. After contacting with the article or supported composition comprising the blended composition, the concentration of bacteria can be equal to or less than a target concentration of bacteria. When an air or gaseous stream is to be treated, the contacted (or treated) stream has a concentration of bacteria equal to or less than a target concentration of bacteria. In particular of these embodiments, the bacteria are fecal coliform bacteria.

In certain embodiments, the biological contaminants to be removed are protozoa (e.g., amoebae). After contacting with the article or supported composition comprising the blended composition, the concentration of protozoa (e.g., amoebae) can be equal to or less than a target concentration of protozoa (e.g., amoebae). When an air or gaseous stream is to be treated, the contacted (or treated) stream has the concentration of protozoa (e.g. amoebae) equal to or less than a target concentration of protozoa (e.g., amoebae). In particular of these embodiments, the protozoa (e.g., amoebae) to be removed are Naegleria fowleri and/or Cryptosporidium.

In certain embodiments, the biological contaminants to be removed are fungi (e.g., mold). After contacting with the article or supported composition comprising the blended composition, the concentration of fungi can be equal to or less than a target concentration of fungi. When an air or gaseous stream is to be treated, the contacted (or treated) stream has a concentration of fungi equal to or less than a target concentration of fungi. In particular of these embodiments, the fungi to be removed are Trichophyton mentagrophytes and/or Aspergillus.

The concentration of contaminant after contacting with a supported composition or material or article comprising the blended composition can be about 45 colony forming units CFU/ml to 5×10⁵ CFU/ml. The target concentration can be set at a certain amount of contaminant (e.g., virus, bacteria, amoeba, fungi) CFU per ml or can be set at the limit of detection.

In some embodiments, the blended composition per se is slurried with the biological contaminant-containing aqueous stream. It can be appreciated that the blended composition of silver zinc zeolite and particulate oxide composition and the biological contaminant-containing aqueous stream are contacted when they are slurried. While not wanting to be bound by any theory, it is believed that some, if not most or all of the biological contaminant contained in the biological contaminant-containing aqueous stream is removed from the biological contaminant-containing aqueous stream by the slurring and/or contacting of the blended composition comprising trivalent doped cerium oxide particulate composition and silver zinc zeolite with the biological contaminant-containing aqueous stream. Following the slurring and/or contacting of the blended composition with the biological contaminant-containing aqueous stream, the slurry is filtered by any known solid liquid separation method. The blended composition and particulate oxide composition utilized in methods including slurrying include all of the embodiments as described herein.

### EXAMPLES

The following Examples are provided to illustrate the particulate oxide composition and methods in more detail, although the scope of the invention is never limited thereby in any way.

Scanning electron microscope (SEM) images were collected using a FEG Zeiss ultra 55 (resolution 1 nm). Transmission electron microscope (TEM) images were collected using a FEI Titan Themis 200 (resolution 0.09 nm). Surface area, pore radius, and pore volume were measured by the BET/BJH method (ASTM D3663-20). The Hg-porosity and total Hg-pore volume were measured using a Micromeritics Autopore IV 9500 system. The procedures outlined in ASTM International test method D 4284-07 were followed. The particle size was measured using a Microtrac S3500. X-ray Diffraction was performed using a Bruker D2 Phaser X-Ray Diffactometer. The peak width at half height was used to determine the crystallite size. The zeta potential vs. pH was measured using a Malvern Panalytical (Zetaziser Nano ZS) ZEN3600 using a procedure similar to ASTM E2865-12(2018). As will be appreciated, crystallite sizes are measured by XRD or TEM and are the size of the individual crystals. The Dx sizes are the size of the particles that are made-up of the individual crystallites and is measured by laser diffraction. The temperature programmed desorption of CO₂ was performed as described in Hakim, A. et al. Temperature Programmed Desorption of Carbon Dioxide for Activated Carbon supported Nickel Oxide: The Adsorption and Desorption Studies, Advanced Materials Research, Vol. 1087 (2015) pp 45-49. The hydrogen temperature programmed reduction was performed as described in Hurst, N. W. et al. Temperature Programmed Reduction. Catalysis Reviews Science and Engineering, 24:2, 233-309. Depth profilometry was performed as described in Noël, C. et al. ToF-SIMS Depth Profiling of Organic Delta Layers with Low-Energy Cesium Ions: Depth Resolution Assessment, Journal of The American Society for Mass Spectrometry, Vol. 30 (2019) pp 1537-1544.

### Example 1

A trivalent doped cerium oxide composition was prepared by the following method. 68 g (0.297 mol) of lanthanum carbonate and 464 g (2.7 mol) cerium oxide were mixed with 200 ml of a 1.0 mol/L lanthanum nitrate solution. The ingredients were mixed for 2 hours. The mixture was then heated in a furnace to 550° C. for 2 hours to obtain 542 g of a mixed cerium lanthanum oxide which is approximately 15% lanthanum oxide by weight. This could also be called a La doped cerium oxide.

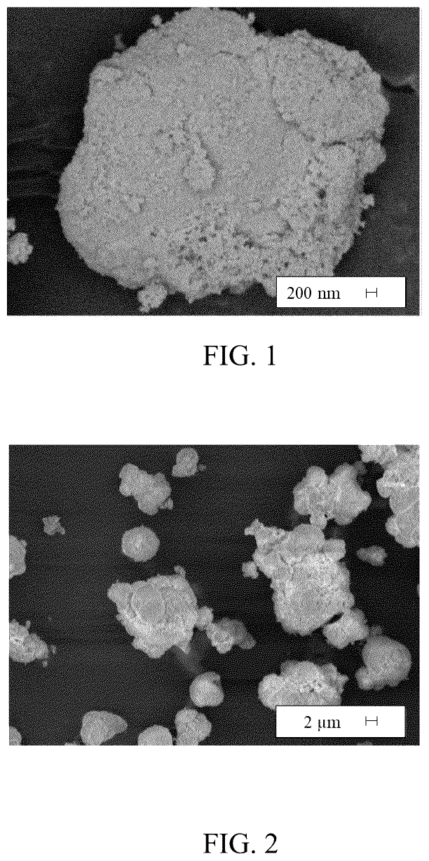

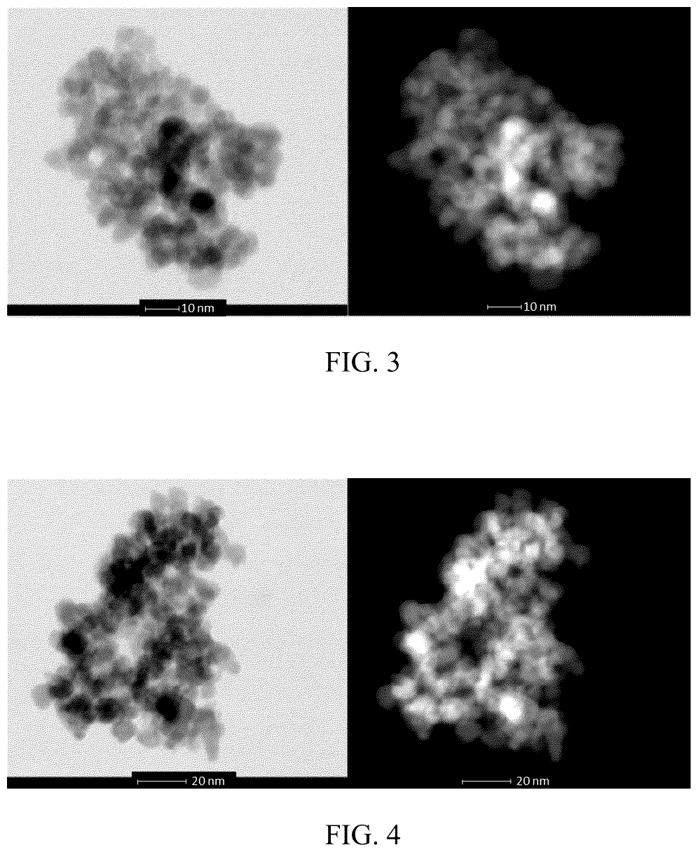

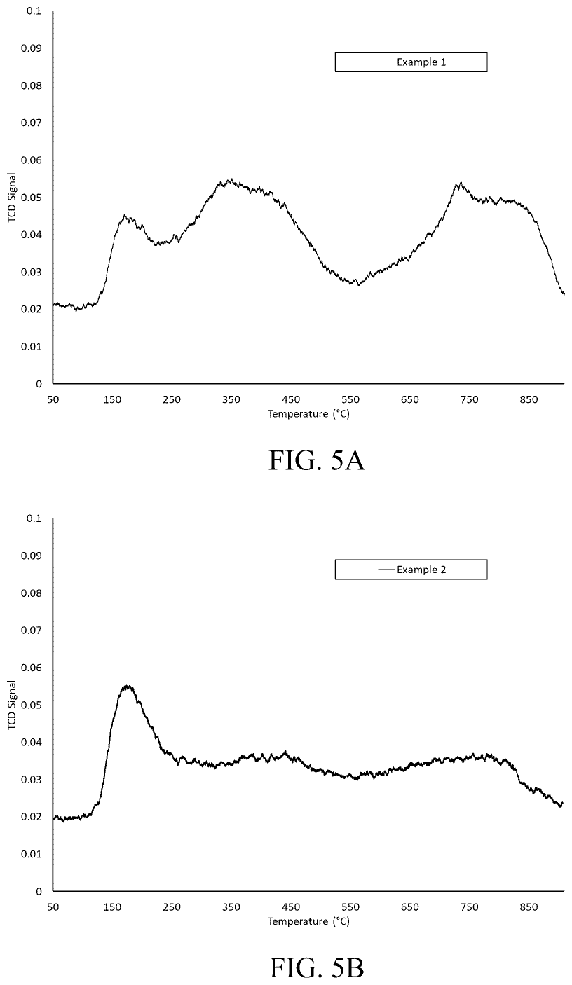

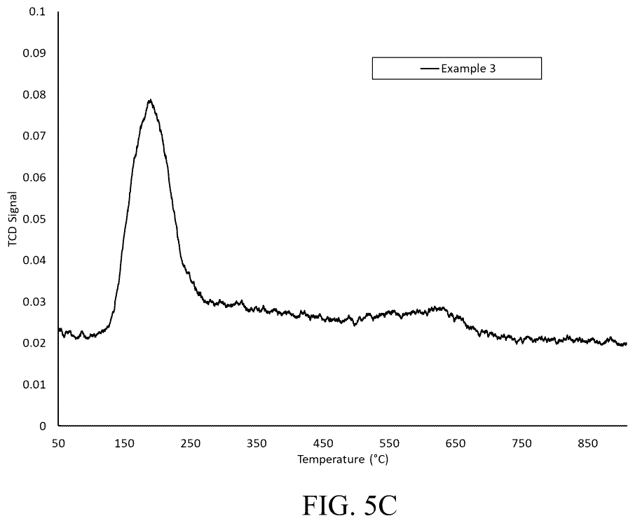

Scanning electron microscope (SEM) images for a sample of the example 1 composition were collected and are displayed in FIGS. 1 and 2. The images reveal a porous material that somewhat spherical in shape. Transmission electron microscope (TEM) images for a sample of the example 1 composition were collected and FIGS. 3 and 4 are the images. The images reveal clusters of spheres. A sample of the example 1 composition was analyzed for surface area, pore radius, and pore volume and found to be 98.332 m²/g (BET) and 135.268 m²/g (BJH) with a pore radius of 3.235 nm and pore volume of 0.248 cc/g. The measured Hg-porosity was measured to be 0.21 cc/g, with pore size <1 μm was 0.46 cc/g, and the total pore volume was 0.96 cc/g. The particle size distribution was measured as described above with the results being D10 3.552 μm, D50 12.1 μm, and D90 43.12 μm. The crystallite size as measured by XRD was determined to be 9.77 nm. The temperature programmed desorption profile is FIG. 5A. The desorption of CO₂ had 3 peak temperatures 172° C., 350° C. and 735° C. indicating both physisorption and chemisorption of CO₂. The H₂ TPR is depicted in FIG. 6 and shows an intense peak around 500° C. in stark contrast to examples 2 and 3 which had broader peaks. The zeta-potential as a function of pH is presented in FIG. 7. The isoelectric point (IEP) was found to be 8.1. The ratio of LaO⁺ to ¹⁴⁰CeO⁺ as a function of depth is plotted in FIG. 8. It should be noted the LaO⁺ to CeO⁺ ratio is higher at shallower depths and approaches a constant level as the depth increases. This indicates the concentration of La is higher on the surface and closer to the surface for the material from Example 1. The Example 1 material is an embodiment of the trivalent doped cerium oxide having the unique depth profile.

### Example 2

A trivalent doped cerium oxide composition was prepared by the following method also as described in U.S. patent application Ser. No. 17/870,068. 129 ml of a 1 mol/L Ce(NO₃)₄ solution was mixed with 24 ml of a 1 mol/L La(NO₃)₃ solution. The resulting solution was heated to reflux for at least 2 hours. 5.5 mol/L NH₄OH was then added to a pH of 10. The resulting solid was filtered and washed with DI water until the wash water was <15 mS/cm. The resulting powder was heated in a furnace in air at 550° C. for at least 2 hours to obtain a mixed cerium lanthanum oxide which is approximately 15% lanthanum oxide by weight. This could also be called a La doped cerium oxide.

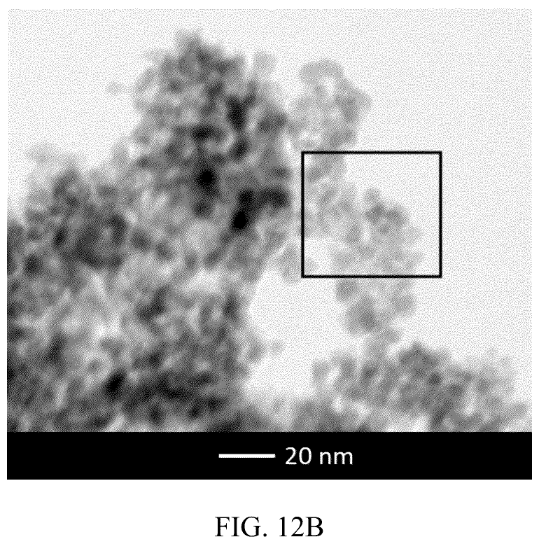

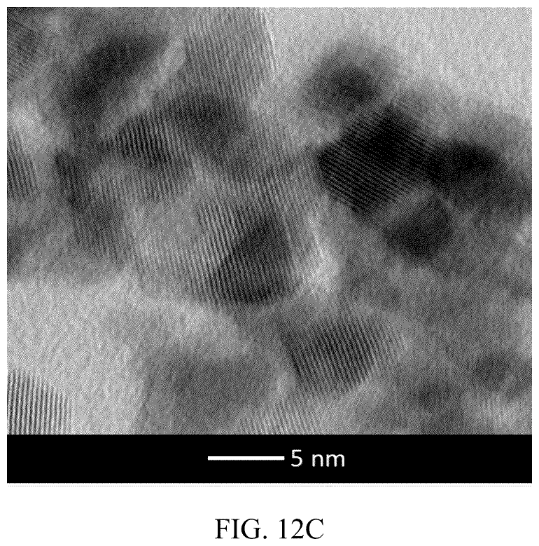

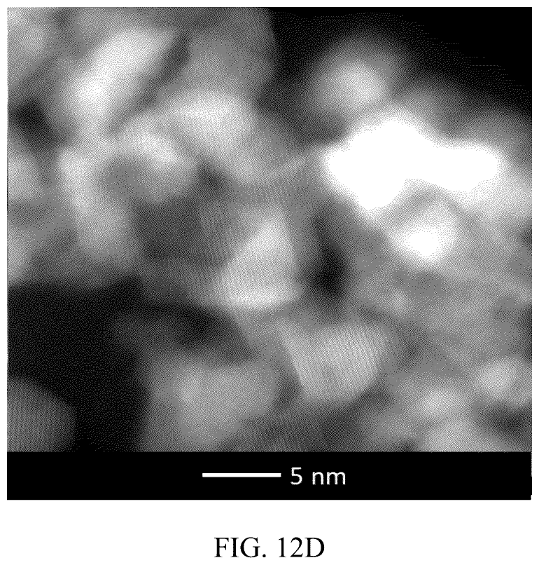

FIGS. 10 and 11 are the SEM images. The images reveal a porous material that somewhat spherical in shape. FIGS. 12A-12D contains the TEM images. The images reveal clusters of spheres and diffraction planes can be seen. The surface area was found to be 120.464 m²/g (BET) and 143.087 m²/g (BJH) with a pore radius of 3.245 nm and pore volume of 0.285 cc/g. The measured pore volume with pore size <0.1 μm was measured to be 0.23 cc/g, with pore size <1 μm was 0.45 cc/g, and the total pore volume was 0.99 cc/g. The particle size distribution was measured as described above with the results being D10 1.301 μm, D50 5.545 μm, and D90 13.109 μm. The crystallite size as measured by XRD was determined to be 9.03 nm. The temperature programmed desorption profile is FIG. 5B. The desorption of CO₂ had 1 peak temperature at 175° C. indicating only physisorption of CO₂. Any peaks at higher temperatures are not distinguished from the background and thus chemisorption of CO₂ is not detected. The H₂ TPR is depicted in FIG. 6 and shows a broad peak around 566° C. The zeta-potential as a function of pH is presented in FIG. 7. The isoelectric point (IEP) was found to be 7.34.

The ratio of LaO⁺ to ¹⁴⁰CeO⁺ as a function of depth is plotted in FIG. 8. It should be noted this material has a near constant LaO⁺ to CeO⁺ ratio from the surface to the maximum measured depth. This indicates the concentration of La is nearly the same on the surface as it is at depth.

### Example 3

A cerium (IV) oxide composition was prepared by the following method. In a closed, stirred container a one liter of a 0.12 M cerium (IV) ammonium nitrate solution was prepared from cerium (IV) ammonium nitrate crystals dissolved in nitric acid and held at approximately 90° C. for about 24 hours. In a separate container 200 ml of a 3M ammonium hydroxide solution was prepared and held at room temperature. Subsequently the two solutions were combined and stirred for approximately one hour. The resultant precipitate was filtered using Buchner funnel equipped with filter paper. The solids were then thoroughly washed in the Buchner using deionized water. Following the washing/filtering step, the wet hydrate was calcined in a muffle furnace at approximately 450° C. for three hours to form the cerium (IV) oxide composition.

The surface area was found to be 126 m²/g (BET) and 167 m²/g (BJH) with a pore radius of 3.62 nm and pore volume of 0.309 cc/g. The measured pore volume with pore size <0.1 μm was measured to be 0.24 cc/g, with pore size <1 μm was 0.35 cc/g, and the total pore volume was 0.85 cc/g. The particle size distribution was measured as described above with the results being D10 2 μm, D50 9 μm, and D90 25 μm. The crystallite size as measured by XRD was determined to be 8.43 nm. The temperature programmed desorption profile is FIG. 5C. The desorption of CO₂ had 1 peak temperature at 175° C. indicating only physisorption of CO₂. Any peaks at higher temperatures are not distinguished from the background and thus chemisorption of CO₂ is not detected. The H₂ TPR is depicted in FIG. 6 and shows broad peaks around 500 and 900° C. The zeta-potential as a function of pH is presented in FIG. 7. The isoelectric point (IEP) was found to be 7.22.

Depth profilometry was not performed as Ce was the only component in this sample. This sample contained no trivalent dopant.

### Example 4

A trivalent doped cerium oxide composition was prepared by the following method. In a closed, stirred container a one liter of a 0.12 M cerium (IV) ammonium nitrate solution was prepared from cerium (IV) ammonium nitrate crystals dissolved in nitric acid. To this was added 199.5 g (0.5 mol) commercially available Al(NO₃)₃ and held at approximately 90° C. for about 24 hours. In a separate container 200 ml of a 3M ammonium hydroxide solution was prepared and held at room temperature. Subsequently the two solutions were combined and stirred for approximately one hour. The resultant precipitate was filtered using Buchner funnel equipped with filter paper. The solids were then thoroughly washed in the Buchner using deionized water. Following the washing/filtering step, the wet hydrate was calcined in a muffle furnace at approximately 450° C. for three hours to form an aluminum cerium (IV) oxide composition. This oxide was suspended in a Praseodymium nitrate solution containing Praseodymium carbonate. The Pr to aluminum cerium (IV) oxide ratio was varied to achieve a 4%, 8%, 12% or 20% loading of Pr oxide on the final product. The ingredients were mixed for 2 hours. The mixture was then heated in a furnace to 550° C. for 2 hours to obtain a mixed cerium aluminum praseodymium oxide. This could also be called a Pr doped cerium oxide.

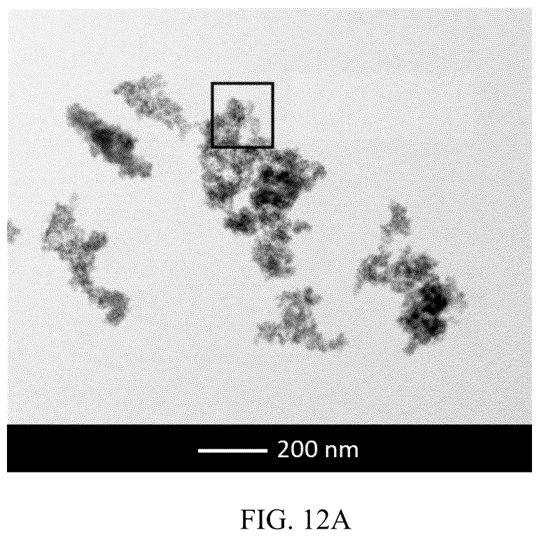

The depth profile of each of these materials was then measured and the PrO⁺ to ¹⁴⁰CeO⁺ ratio vs depth is presented in FIG. 9. As with Example 1 the trivalent, in this case PrO⁺, to ¹⁴⁰CeO⁺ ratio is higher at the surface and shallower depths and approaches a constant level as the depth increases. The Example 4 materials are embodiments of the trivalent doped cerium oxide having the unique depth profile.

### Example 5

A praseodymium doped cerium oxide composition was prepared by the following method. This method is similar to the method of Example 2. 129 ml of a 1 mol/L Ce(NO₃)₄ solution was mixed with 82 ml of a 1 mol/L Pr(NO₃)₃ solution and 63.9 g (0.3 mol) commercially available Al(NO₃)₃. The resulting solution was heated to reflux for at least 2 hours. 5.5 mol/L NH₄OH was then added to a pH of 10. The resulting solid was filtered and washed with DI water until the wash water was <15 mS/cm. The resulting powder was heated in a furnace in air at 550° C. for at least 2 hours to obtain a mixed cerium aluminum praseodymium oxide which contains approximately 16% Pr oxide by weight. This could also be called a Pr doped cerium oxide.

The depth profile was measured and the data is presented in FIG. 9. As in example 2 the trivalent, in this case PrO⁺, to ¹⁴⁰CeO⁺ ratio is nearly constant from the surface to the maximum depth measured. This indicates the concentration of Pr is nearly the same on the surface as it is at depth.

The depth profile data from examples 1, 2, 4, and 5 were then compared by averaging the trivalent to Ce ratio (LaO⁺/CeO⁺ or PrO⁺/CeO⁺) at depths of 0 to 3.5 nm. This average was then compared to the same ratio at a depth of 15 nm. The % increase was then calculated

$$( ( A verage between 0 and 3.5 nm ) - ( ratio at 15 nm ) ) / ( ratio at 15 nm ) \times 100.$$

TABLE 1
Comparison of average LaO⁺/CeO⁺ or PrO⁺/
CeO⁺ ratio from 0 to 3.5 nm vs ratio at 15 nm

| | Average ratio | | |
|---|---|---|---|
| Material | from 0 to 3.5 nm | Ratio at 15 nm | % increase |
| Example 1 | 0.3386 | 0.2548 | 32.9 |
| Example 2 | 0.2826 | 0.2638 | 7.15 |
| Example 4 @4% | 0.9793 | 0.3929 | 149 |
| Example 4 @8% | 1.9280 | 0.6920 | 178 |
| Example 4 @12% | 3.0797 | 1.0156 | 203 |
| Example 4 @20% | 5.6259 | 2.0905 | 169 |
| Example 5 | 0.0386 | 0.0529 | −27 |

### Example 6

A commercially available inorganic antimicrobial agent was obtained from a supplier (Surfatas) under the commercial name Life DJ/AM-00-1A (CAS #130328-20-0). The product literature describes this material as having a silver content of 2.5% and a zinc content of 10-16%. The remainder of this material is a zeolite. It is registered as a pesticide with the EPA under EPA Registration No. 71227-1-85576. Alternatively, this material can be made by the method described in Iyigündo\check{g}du et al. Development of durable antimicrobial surfaces containing silver- and zinc-ion-exchanged zeolites, Turkish Journal of Biology, Vol. 38: No. 3, Article 14, (2014) pp 420-427. Briefly, this method involves the hydrothermal synthesis of the zeolite followed by ion-exchange of the sodium (Na) contained in the zeolite with silver (Ag) and zinc (Zn) by treatment with individual solutions of AgNO₃ and ZnCl₂.

### Example 7A

To make the blended powders, a measured amount of the composition of example 1 was placed in a container along with a measured amount of the material from example 6. In this example, 9 g of example 1 was placed in a 60 ml polyethylene bottle. Then 1 g of example 6 was added. Thus, the mixture was 90% example 1 and 10% example 6. The bottle was sealed and placed in a tumbler which rotated the bottle in such a way that the bottle was inverted once per second. The bottle was tumbled in this fashion for at least 1 hr. The resulting mixture was used without further modification. No chemical reaction was expected. The materials were only blended together as dry powders. The blended powders were characterized by measuring the BET surface area and pore radius. BHJ methods are not valid for zeolites which makes the pore volume meaningless, thus the BHJ surface area and pore volume are not reported. The results are compiled in Table 2.

### Example 7B

The material of Example 7B was prepared and characterized as in example 7A with the exception of 7.5 g of example 1 was used and 2.5 g of example 6 was used to yield a mixture that is 75% example 1 and 25% example 6.

### Example 7C

The material of Example 7C was prepared and characterized as in example 7A with the exception of 5.0 g of example 1 was used and 5.0 g of example 6 was used to yield a mixture that is 50% example 1 and 50% example 6. The particle size distribution D50, D90, and D100 were also measured for this blend and the results are compiled in Table 2.

### Example 7D

The material of Example 7D was prepared and characterized as in example 7A with the exception of 2.5 g of example 1 was used and 7.5 g of example 6 was used to yield a mixture that is 25% example 1 and 75% example 6.

### Example 8A

To make the blended powders, a measured amount of the composition of example 3 was placed in a container along with a measured amount of the material from example 6. In this example, 9 g of example 3 was placed in a 60 ml polyethylene bottle. Then 1 g of example 6 was added. Thus the mixture was 90% example 3 and 10% example 6. The bottle was sealed and placed in a tumbler which rotated the bottle in such a way that the bottle was inverted once per second. The bottle was tumbled in this fashion for at least 1 hr. The resulting mixture was used without further modification. No chemical reaction was expected. The materials were only blended together as dry powders. The blended powders were characterized by measuring the BET surface area, pore radius, pore volume. The results are compiled in Table 2.

### Example 8B

The material of Example 8B was prepared and characterized as in example 8A with the exception of 7.5 g of example 3 was used and 2.5 g of example 6 was used to yield a mixture that is 75% example 3 and 25% example 6.

### Example 8C

The material of Example 8C was prepared and characterized as in example 8A with the exception of 5.0 g of example 3 was used and 5.0 g of example 6 was used to yield a mixture that is 50% example 3 and 50% example 6.

### Example 8D

The material of Example 8D was prepared and characterized as in example 8A with the exception of 2.5 g of example 3 was used and 7.5 g of example 6 was used to yield a mixture that is 25% example 3 and 75% example 6.

TABLE 2
BET Surface area (SA), Pore Radius, D50, D90, and
D100 of Examples 1, 2, 3, 6, 7A-7D, and 8A-8D.

| | BET SA | Pore Radius | D50 | D90 | D100 |
|---|---|---|---|---|---|
| Example | (m2/g) | (nm) | (μm) | (μm) | (μm) |
| 1 | 98.337 | 3.235 | 5.845 | 15.76 | 40.5 |
| 7A | 127.261 | 2.941 | | | |
| 7B | 165.53 | 2.93 | | | |
| 7C | 238.012 | 2.961 | 2.905 | 8.183 | 21.125 |
| 7D | 316.163 | 1.958 | | | |
| 3 | 154.451 | 1.823 | | | |
| 8A | 179.069 | 1.841 | | | |
| 8B | 200.113 | 1.835 | | | |
| 8C | 257.506 | 1.838 | | | |
| 8D | 320.461 | 1.953 | | | |
| 6 | 402.385 | 1.962 | 2.651 | 4.838 | 9.688 |

The trend in the BET SA and pore radius for these blended powders supports these being physical mixtures only. Also, the D50, D90, and D100 for example 1, blended example 7C, and example 6 also supports these being physical mixtures. One would expect a physical mixture of 2 powders to have a BET SA, pore radius, and PSD between that of the unblended powders. That is observed here as the proportion of example 6 material is increased, the BET SA and pore radius measured approaches the values of example 6.

### Example 9

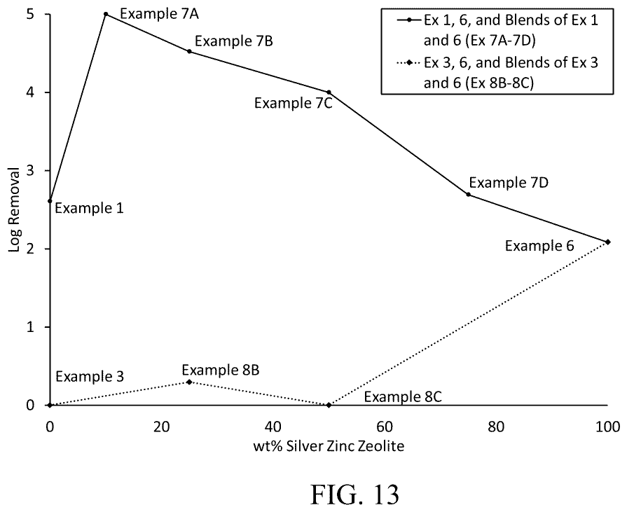

Bacterial Removal Characteristics of the composition of Example 1, 3, 6, 7A-D, and 8B-C were tested using an adapted EN 13727 method. Suspensions of these materials (0.2 g/ml in deionized water) in the amount of 4 ml were added to a mixture of 0.5 ml Methicillin resistant Staphylococcus aureus (MRSA) ATCC® 43300™ suspension and 0.5 ml hard water at room temperature (20±1° C.). At 1 hour, 0.5 mL of mixture was transferred to a tube containing 4 mL neutralizer (Dey Engley broth) and incubated for 5 min=10 s at 20° C.±1° C. Validation suspension (0.5 mL) was then added to each neutralizer tube, mixed, and incubated at 20° C.±1° C. for 30 min±1 min. Suspensions were plated on TSA and assessed for efficacy and toxicity. Results are shown in Table 3 and FIG. 13. These results show the blended materials of 7A-D have increased bacterial removal over the unblended materials of example 1 and 6. In comparison the blended materials of 8B-C do not show increased bacterial removal over the unblended materials of example 3 and 6.

TABLE 3
Reduction of MRSA.

| | % Reduction | Log reduction |
|---|---|---|
| Example | 1 hr | 1 hr |
| 1 | 99.753 | 2.6 |
| 7A | 99.999 | 5.0 |
| 7B | 99.997 | 4.5 |
| 7C | 99.990 | 4.0 |
| 7D | 99.797 | 2.7 |
| 3 | 0.000 | 0.0 |
| 8B | 49.304 | 0.3 |
| 8C | 0.000 | 0.0 |
| 6 | 99.176 | 2.1 |

### Example 10

The material of example 7A is suspended in deionized water and a binder, such as citric acid, is added to the water. A substrate, such as cotton fabric, is then immersed in the suspension at least one time. After removing the substrate, it is allowed to dry. The resulting fabric has a coating of the composition of example 7A its surface. This coated fabric is then placed in a funnel such that fabric will remain in the funnel when water is passed through. Water contaminated with E. coli is then poured into the funnel and comes in contact with the coated fabric. The water collected from the funnel is analyzed and found to have a reduced concentration of E. coli.

### Example 11

The material of example 7A is suspended in deionized water and a binder, such as citric acid, is added to the water. A substrate, such as cotton fabric, is then immersed in the suspension at least one time. After removing the substrate, it is allowed to dry. The resulting fabric has a coating of the composition of example 1 its surface. This coated fabric is then placed on an air filter such that fabric covers the face of the air filter and air can pass though the fabric. The filter is then placed in an HVAC or room air filtration unit. Upon turning on the unit, air contaminated with coronavirus is passed through the filter. The air discharged from the unit is analyzed and found to have a reduced concentration of coronavirus.

### Example 12

Polyethylene granules or powder is mechanically mixed with the material of example 7A such that the material of example 7A is approximately 1% by weight. The mixture is then fed into a heating chamber to form an end use product such as a bottle. After the bottle is formed from the polyethylene containing material from example 7A, the surface to the polyethylene is tested for antibacterial or bacteriostatic properties by exposing the surface to E. coli. The surface is then analyzed for E. coli and found to have less colony forming units than a control. Another test is conducted by putting pasteurized milk in the formed bottle and observing the time necessary for the milk to spoil. Compared a polyethylene bottle without the material of example 7A, the milk takes a longer time to spoil.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained.

Notwithstanding that the numerical ranges and parameters setting forth the broad scope of the technology are approximations, the numerical values set forth in the specific examples are reported as precisely as possible. Any numerical value, however, inherently contain certain errors necessarily resulting from the standard deviation found in their respective testing measurements.

It will be clear that the compositions and methods described herein are well adapted to attain the ends and advantages mentioned as well as those inherent therein. Those skilled in the art will recognize that the methods and systems within this specification may be implemented in many manners and as such are not to be limited by the foregoing exemplified embodiments and examples. In this regard, any number of the features of the different embodiments described herein may be combined into one single embodiment and alternate embodiments having fewer than or more than all of the features herein described are possible.

While various embodiments have been described for purposes of this disclosure, various changes and modifications may be made which are well within the scope contemplated by the present disclosure. Numerous other changes may be made which will readily suggest themselves to those skilled in the art and which are encompassed in the spirit of the disclosure.

What is claimed is:

1. A blended composition for biological contaminant removal comprising:
(a) less than about 50% to about 1% by weight of a silver zinc zeolite; and
(b) greater than about 50% to about 99% by weight of a particulate oxide composition comprising:
cerium oxide;
trivalent dopant selected from the group consisting of yttrium (Y), lanthanum (La), neodymium (Nd), praseodymium (Pr), and mixtures thereof, and
optionally an additional metal oxide selected from the group consisting of aluminum (Al), titanium (Ti), zirconium (Zr), hafnium (Hf), and mixtures thereof,
wherein the cerium oxide is present in an amount greater than the trivalent dopant and wherein the average trivalent dopant to Ce ratio at about 0 nm to about 3.5 nm from the surface of the particulate oxide composition is greater than the trivalent dopant to Ce ratio at about 15 nm from the surface of the particulate composition.

2. The blended composition of claim 1, wherein the silver zinc zeolite is a silver and zinc ion surface-modified Linde Type A (LTA) zeolite.

3. The blended composition of claim 1, wherein the particulate oxide composition comprises:
cerium oxide in an amount of about 99.9 wt % to about 20 wt % based on the total weight of the particulate oxide composition;
trivalent dopant in an amount of about 0.1 wt % up to about 50 wt % based on the total weight of the particulate oxide composition; and
additional metal oxide in an amount of about 70 wt % to about 0 wt % based on the total weight of the particulate oxide composition.

4. The blended composition of claim 1, comprising:
(a) about 35% to about 5% by weight of a silver zinc zeolite; and
(b) about 65% to about 95% by weight of a particulate oxide composition.

5. The blended composition of claim 1, wherein the particulate oxide composition comprises:
cerium oxide in an amount of about 99.9 wt % to about 50 wt % based on the total weight of the particulate oxide composition; and
trivalent dopant in an amount of about 0.1 wt % up to about 50 wt % based on the total weight of the particulate oxide composition.

6. The blended composition of claim 1, wherein the particulate oxide composition comprises:
cerium oxide in an amount of about 20 wt % to about 30 wt % based on the total weight of the particulate oxide composition;
trivalent dopant in an amount of about 2 wt % to about 25 wt % based on the total weight of the particulate oxide composition; and
additional metal oxide in an amount of about 45 wt % to about 78 wt % based on the total weight of the particulate oxide composition.

7. The blended composition of claim 1, wherein the particulate oxide composition comprises:
cerium oxide in an amount of about 45 wt % to about 78 wt % based on the total weight of the particulate oxide composition;
trivalent dopant in an amount of about 2 wt % to about 25 wt % based on the total weight of the particulate oxide composition; and
additional metal oxide in an amount of about 20 wt % to about 30 wt % based on the total weight of the particulate oxide composition.

8. The blended composition of claim 1, wherein in the particulate oxide composition, the average trivalent dopant to Ce ratio at about 0 nm to about 3.5 nm from the surface of the particulate composition is about 10% to about 250% greater than the trivalent dopant to Ce ratio at about 15 nm from the surface of the particulate oxide composition.

9. The blended composition of claim 8, wherein in the particulate oxide composition, the average trivalent dopant to Ce ratio at about 0 nm to about 3.5 nm from the surface of the particulate composition is about 15% to about 250% greater than the trivalent dopant to Ce ratio at about 15 nm from the surface of the particulate oxide composition.

10. The blended composition of claim 1, wherein the particulate oxide composition comprises about 2 wt % to about 30 wt % trivalent dopant.

11. The blended composition of claim 1, comprising:
(a) about 25% to about 10% by weight of a silver zinc zeolite; and
(b) about 75% to about 90% by weight of a particulate oxide composition.

12. A supported composition for removing biological contaminants comprising:
a support material comprising an organic polymer, cotton, glass fiber, or mixtures thereof, and the blended composition for biological contaminant removal of claim 1,
wherein the blended composition for biological contaminant removal is deposited on or within the support material.

13. The supported composition of claim 12, wherein the support material is an organic polymer selected from the group consisting of polyethylene, polyvinyl chloride, nylon, polypropylene, polyester, polyurethane, polyamide, polyolefin, polycarbonate, copolymers thereof, and mixtures thereof.

14. The supported composition of claim 12, wherein the support material is cotton.

15. The supported composition of claim 12, wherein the supported composition comprises about 0.5 to about 80 weight % of the composition for biological contaminant removal based on the total weight of the supported composition.

16. The supported composition of claim 12, wherein the supported composition is a filter material or a plastic.

17. A method for removing biological contaminants comprising:
providing blended composition of claim 1;
contacting the blended composition with a biological contaminant wherein the biological contaminant is selected from the group consisting of bacteria, viruses, protozoa, fungi, and mixtures thereof; and
removing at least about 90% of the biological contaminant through contact with the blended composition.

18. The method of claim 17, wherein the blended composition is contained within a filter material or a plastic.

19. The method of claim 17, wherein the blended composition for biological contaminant removal is deposited on or within a support material comprising an organic polymer, cotton, glass fiber, or mixtures thereof.

20. The method of claim 17, wherein the blended composition for biological contaminant removal removes approximately 99% or more of the biological contaminants.

21. The method of claim 17, wherein the biological contaminant is in an aqueous stream or a gaseous stream or a mixture thereof.

22. The method of claim 17, wherein the contacting is through touch of a solid to an article comprising the blended composition for biological contaminant removal.

23. The method of claim 17, further comprising the steps of setting a target concentration of biological contaminant and monitoring after contacting for the biological contaminant.

24. A plastic article comprising:
(a) a supported composition for removing biological contaminants comprising: an organic polymer selected from the group consisting of polyethylene, polyvinyl chloride, nylon, polypropylene, polyester, polyurethane, polyamide, polyolefin, polycarbonate, copolymers thereof, and mixtures thereof, and the blended composition for biological contaminant removal of claim 1, wherein in the supported composition, the blended composition is deposited on or within the organic polymer; and
wherein the plastic article comprises about 50 to about 100 weight percent of the supported composition based on the total weight of the plastic article.
